(19) United States
(12) Patent Application Publication
(10) Pub. No.: US 2026/0187645 A1
(43) Pub. Date: Jul. 2, 2026

(54) SYSTEMS AND METHODS FOR GENERATING CUSTOMER INTELLIGENCE FROM STRUCTURED AND UNSTRUCTURED DATA

(71) Applicant: FunnelStory Inc., Cupertino, CA (US)

(72) Inventors: Preetam Jinka, Santa Clara, CA (US); Arun Balakrishnan, Sunnyvale, CA (US); Alok Shukla, Cupertino, CA (US)

(21) Appl. No.: 19/547,204

(22) Filed: Feb. 23, 2026

Related U.S. Application Data
(60) Provisional application No. 63/671,607, filed on Jul. 15, 2024.

(51) Int. Cl. G06Q 30/01; G06F 16/901

(52) U.S. Cl. CPC G06Q 30/01; G06F 16/9024

(57) ABSTRACT

Systems and methods for generating customer intelligence which can include: receiving structured data from one or more data sources associated with a plurality of customer accounts, the structured data comprising customer activity records; receiving unstructured conversational data associated with one or more of the plurality of customer accounts; analyzing, by a trained language model, the unstructured conversational data to extract a plurality of behavioral signal indicators, each behavioral signal indicator comprising a categorization and a temporal attribute associated with a customer account; constructing a customer intelligence graph; performing temporal analysis on the customer intelligence graph to identify, for a given customer account, a pattern among the temporal relationships between the account entities and the behavioral signal entities associated with the given customer account; and generating, based on the identified pattern, a predictive account assessment indicating a predicted change in status of the given customer account.

### CROSS-REFERENCE TO RELATED APPLICATIONS

This Application claims the benefit of U.S. Provisional Application No. 63/761,607, filed on 21 Feb. 2025, which is incorporated in its entirety by this reference.

### TECHNICAL FIELD

The invention relates generally to the field of digital customer intelligence platforms, and more specifically to new and useful systems and methods for generating customer intelligence from structured and unstructured data.

### BACKGROUND OF THE INVENTION

In business-to-business (B2B) and business-to-consumer (B2C) environments, understanding customer behavior and predicting changes in customer account status (e.g., churn risk, expansion readiness, and product adoption) is a significant concern for organizations across various industries. Traditional methods of analyzing customer health rely primarily on structured data, such as customer demographics, transaction history, and product usage metrics collected from customer relationship management (CRM) systems, data warehouses, and product analytics platforms. However, these methods often fail to capture nuances of customer behavior and sentiment that may be found in unstructured data, such as meeting transcripts, email correspondence, support tickets, and instant messages. In a typical vendor organization, multiple teams (e.g., sales, marketing, product management, engineering, customer success, customer support, and executives) interact with a customer across varied communication channels (e.g., email, phone, video conferencing, in-person meetings, support tickets, instant messaging, and web chat). When the customer is a medium to large-sized organization, different individuals within the customer organization may interact with different vendor teams through different communication modes. As a result, insights about a customer's experience, sentiment, and trajectory may be fragmented across multiple systems and communication channels, making it difficult for any single team or system to develop a comprehensive understanding of the customer's status.

Furthermore, traditional methods of customer journey analysis are often manual, time-consuming, and lack the ability to adapt to real-time data. To effectively understand a customer and assess the risk of churn or the potential for expansion, a vendor organization may need to know how a customer is using the vendor's product, whether the customer is realizing value from the product, and how the customer feels about the product and the vendor relationship. Traditional methods for analyzing customer conversations and interactions are manual, which may be time-consuming, inconsistent, and not comprehensive.

Thus, there is a need in the digital customer intelligence field to create a new and useful system and method for generating customer intelligence from structured and unstructured data. This invention provides such a new and useful system and method.

### BRIEF DESCRIPTION OF DRAWINGS

FIG. 1 is a flowchart of a method for generating customer intelligence from structured and unstructured data.

FIG. 2 is a flowchart of the method variation including optional orchestration processing.

FIG. 3 is a flowchart of a method for generating customer intelligence adapted for customer journey analysis.

FIG. 4 is a flowchart of a method for generating customer intelligence adapted for behavioral signal analysis.

FIG. 5A is a flowchart of sub-steps for extracting behavioral signal indicators from unstructured data.

FIG. 5B is a flowchart of sub-steps for constructing a customer intelligence graph.

FIG. 5C is a flowchart of sub-steps for performing temporal analysis and generating a predictive assessment adapted for churn prediction.

FIG. 6 is a schematic diagram of a customer intelligence system showing data flow among system modules.

FIG. 7 is a schematic diagram of an orchestration module showing an instruction validation pipeline, agent types, and execution outputs.

FIG. 8 is a schematic diagram of a journey analysis module and customer intelligence graph.

FIG. 9 is a schematic diagram of a system for generating customer intelligence from structured and unstructured data.

FIG. 10 is a diagram depicting an example event log of timestamped activity records associated with customer accounts.

FIG. 11 is a diagram depicting a conversation analysis pipeline including context provision, language model processing, and signal category extraction.

FIG. 12 is a flowchart of a prediction model training pipeline.

FIG. 13 is a diagram depicting configuration of account tags used for training prediction models with examples of tagging churned and retained account.

FIG. 14 is a diagram depicting configuration of a tag based on filter criteria.

FIG. 15 is a diagram depicting feature contribution analysis output from a prediction model.

FIG. 16 is a diagram depicting a generated analysis based on prediction model output.

FIG. 17 is a diagram depicting a hypothetical scenario analysis interface.

FIG. 18 is a diagram depicting behavioral signal indicator analysis generated from unstructured data.

FIG. 19 is a diagram depicting a customer journey map showing activity relationships, journey paths, durations, and retention zones.

FIG. 20 is a diagram depicting sequential stage definition with gating conditions.

FIG. 21 is a diagram depicting stage progression visualization showing account distribution across sequential stages.

FIG. 22 is a diagram depicting stage progression visualization including median time metrics for each stage.

FIG. 23 is a diagram depicting individual account stage detail including progression status labels.

FIG. 24 is a diagram depicting individual account stage detail including gating condition status and historical comparison data.

FIG. 25 is a diagram depicting a behavioral signal indicator detail view including a signal category, an AI-generated summary, an activity timeline of associated conversations, supporting text excerpts, and sentiment indicators.

FIG. 26 is an exemplary system architecture that may be used in implementing the system and/or method.

### DETAILED DESCRIPTION OF THE EMBODIMENTS

The following description of the embodiments of the invention is not intended to limit the invention to these embodiments but rather to enable a person skilled in the art to make and use this invention.

### 1. Overview

The systems and methods described herein provide a computer-implemented approach for generating customer intelligence by combining structured activity data with conversational data. In general, the systems and methods may receive structured data (e.g., timestamped customer activity records from CRM systems, data warehouses, product analytics platforms, and billing systems) and unstructured conversational data (e.g., meeting transcripts, email correspondence, support tickets, instant messages, and call recordings) associated with a plurality of customer accounts. The systems and methods may then analyze the unstructured conversational data using a trained language model to extract behavioral signal indicators, which may capture categorized behavioral observations with temporal attributes. The systems and methods may construct a customer intelligence graph that stores account entities derived from the structured data, behavioral signal entities derived from the extracted behavioral signal indicators, and temporal relationships linking the account entities and the behavioral signal entities across a time dimension. The systems and methods may then perform temporal analysis on the customer intelligence graph to identify patterns among the temporal relationships and generate predictive account assessments indicating predicted changes in customer account status.

The systems and methods described herein may be applied to a variety of customer intelligence applications. As one application, the systems and methods may be used for churn prediction (or other forms of customer status change predictions like retention or growth prediction), wherein the predictive account assessment indicates a predicted likelihood that a customer account will discontinue use of a product or service within a defined future time period. In this application, the systems and methods may compute a composite score that combines a structured score derived from machine learning models trained on historical customer account outcomes with an unstructured score based on temporal frequency, sentiment, and recency of behavioral signal indicators. The machine learning models may include, for example, one or more of logistic regression, random forest, decision tree, support vector machine, neural network, or an ensemble of two or more of the foregoing, and may be trained using labeled historical data comprising customer accounts identified as churned or retained. The composite score may provide a holistic view of customer account health that incorporates both quantitative usage patterns and qualitative conversational signals. The systems and methods may further provide feature contribution analysis identifying which features and behavioral signal indicators contributed most to a given predictive account assessment, as well as simulated outcome analysis (e.g., what-if analysis) in which one or more features or behavioral signal indicators are modified and the predictive account assessment is recomputed to determine the effect of the modification. Additionally, the systems and methods may generate, using a language model, a human-readable narrative explanation of the predictive account assessment describing the factors that contributed to the predicted change in status. Because the behavioral signal indicators may capture early conversational signals (e.g., competitor mentions, pricing concerns, shifts in sentiment, and product dissatisfaction expressions) that precede observable changes in structured usage data, the systems and methods may generate predictive account assessments well in advance of actual changes in customer account status (e.g., months before a renewal decision), thereby functioning as a leading indicator of customer account health rather than a lagging measure based on historical activity alone.

As another application, the systems and methods may be used for customer journey analysis, wherein temporal analysis of the customer intelligence graph includes generating an event log of timestamped activity records and applying sequential pattern analysis techniques (e.g., process mining) to identify activity relationships, such as prerequisite activities, parallel activities, cyclical activities, milestone events (e.g., 5th user added, pricing discussion 3 months prior to renewal)), and/or other types of activity relationships. The systems and methods may further define a plurality of sequential stages based on the identified activity relationships, each stage associated with one or more gating conditions and evaluate progression of each customer account through the sequential stages using a state machine that replays the timestamped activity records against the gating conditions. This may be used for, for example, generating reporting related to identification of accounts that are ‘on time,’ ‘slow,’ or ‘stuck’ in their journey. The systems and methods may also identify recurring activities correlated with sustained customer engagement (sometimes referred to as a retention zone) and use the identified activities as benchmark criteria for evaluating whether other customer accounts have achieved sustained product value. In this way, the systems and methods may reconstruct historical customer journeys across organizational touchpoints, identify where and how different customer accounts realize value from a product or service, detect growth loops and engagement drivers that distinguish successful accounts, and identify common drop-off points or stalled progression that may indicate risk.

As yet another application, the systems and methods may be used for automated orchestration, wherein the systems and methods generate automated task recommendations based on the predictive account assessment and a current state of a given customer account within the customer intelligence graph. In some variations, the automated task recommendations may be generated by a language model informed by customer success practices. The systems and methods may further automatically execute one or more of the automated task recommendations via programmatic integration with external systems, such as transmitting a communication to a customer contact, updating a record in a CRM system, or creating a task in a project management or support system. In some variations, the orchestration may include agentic functionality, wherein an autonomous agent performs multi-step planning and tool orchestration informed by the customer intelligence graph, contextual memory of prior interactions, and the predictive account assessments. The agentic functionality may autonomously prioritize high-impact actions based on the unique data modeling and processing of the customer intelligence graph, rather than relying on static rules or manual configuration.

The systems and methods described herein include many variations which may be adapted for different objectives or product features. The churn prediction, customer journey analysis, and automated orchestration applications described herein may be used individually or in any suitable combination. For example, the customer journey analysis may inform the churn prediction by providing journey-stage context as an additional input to the predictive account assessment, and the orchestration may act on outputs from both the churn prediction and journey analysis to generate targeted task recommendations. The systems and methods may further include additional variations described herein, such as configurable entity type schemas for mapping heterogeneous data sources, data gap identification and confidence indicators, feature contribution analysis, simulated outcome analysis (e.g., what-if analysis), cluster analysis, and narrative explanation generation. Each of these variations may be combined with or used independently of the applications described above.

The systems and methods described herein are primarily described in the context of B2B customer intelligence for software-as-a-service (SaaS) and subscription-based computing platforms. In one implementation, the systems and methods may be deployed as a multi-tenant SaaS platform used by outside organizations to facilitate enhanced business intelligence within their applications, wherein each tenant organization connects its own data sources, and the platform maintains separate customer intelligence graphs and predictive models for each tenant. In another implementation, the systems and methods may be deployed as a single-instance implementation within an organization's own infrastructure, wherein the organization uses the systems and methods internally for its own customer intelligence objectives. However, the systems and methods may be applied to any suitable context in which structured and unstructured data associated with entities (e.g., customer accounts, user accounts, organizational units, or other tracked entities) may be analyzed to generate predictive assessments and automated actions. For example, the systems and methods may be adapted for use in healthcare patient engagement, financial services client management, educational institution student success tracking, or any other domain where entity behavior may be assessed through a combination of structured activity data and unstructured communications.

The systems and methods may provide a number of potential benefits. The systems and methods are not limited to always providing such benefits, and the following are presented only as exemplary representations of how the systems and methods may be put to use. The list of benefits is not intended to be exhaustive, and other benefits may additionally or alternatively exist.

As one potential benefit, the systems and methods may provide a more comprehensive understanding of customer account health by combining structured data analysis with unstructured conversational data analysis. Traditional approaches may rely solely on structured data such as product usage metrics and transaction history, which may fail to capture nuances of customer behavior and sentiment expressed in conversations, emails, and support interactions. By extracting behavioral signal indicators from unstructured conversational data and integrating them with structured activity data within a customer intelligence graph, the systems and methods may identify patterns and signals that would not be apparent from either data source alone.

As another potential benefit, the systems and methods may detect changes in customer account status earlier than traditional approaches by leveraging behavioral signal indicators as leading indicators. Because conversational signals such as competitor mentions, pricing concerns, sentiment shifts, and product dissatisfaction expressions may appear in unstructured data before observable changes manifest in structured usage metrics, the systems and methods may generate predictive account assessments well in advance of actual changes in customer account status, thereby providing earlier opportunities for intervention.

As another potential benefit, the systems and methods may automate the extraction of behavioral signal indicators from unstructured conversational data using a trained language model. Traditional methods for analyzing customer conversations may be manual, time-consuming, inconsistent, and not comprehensive. By automating this extraction and classifying conversational segments into signal categories from a predefined signal taxonomy, the systems and methods may process a higher volume of conversational data with greater consistency than manual analysis approaches.

As another potential benefit, the systems and methods may generate more accurate predictive account assessments by computing a composite score that combines a structured score derived from machine learning models with an unstructured score based on behavioral signal indicators. By maintaining separate scoring paths for structured and unstructured data and then combining them, the systems and methods may capture complementary dimensions of customer account health and may reduce the likelihood that important signals from either data source are obscured or lost in aggregation.

As another potential benefit, the systems and methods may identify data gaps where expected entity types are absent from the customer intelligence graph or where populated entity data exceeds a staleness threshold. By tracking expected entity types for each customer account and comparing them against the data actually present in the customer intelligence graph, the systems and methods may generate a confidence indicator reflecting data completeness. This may enable users to understand the reliability of a given predictive account assessment and to prioritize data collection efforts for accounts with incomplete information.

As another potential benefit, the systems and methods may automatically reconstruct historical customer journeys by generating event logs from the customer intelligence graph and applying sequential pattern analysis techniques to identify activity relationships. By defining sequential stages with gating conditions and replaying timestamped activity records through a state machine, the systems and methods may evaluate where each customer account stands in its journey and identify accounts that may be progressing slowly or have stalled, without requiring manual journey mapping or static rule configuration.

As another potential benefit, the systems and methods may improve over time through feedback mechanisms. Predictive models may be retrained by comparing generated predictive account assessments against actual customer account outcomes, using the comparison to identify and correct prediction errors in subsequent training iterations. Additionally, user feedback on predictive account assessments may be incorporated into subsequent model training or language model refinement, enabling the systems and methods to adapt to changing customer behaviors and domain-specific patterns.

As another potential benefit, the systems and methods may reduce the manual effort associated with acting on customer intelligence by generating automated task recommendations and executing them via programmatic integration with external systems. Rather than requiring users to manually review predictions and determine appropriate actions, the systems and methods may generate context-aware task recommendations informed by the customer intelligence graph and predictive account assessments, and may automatically execute tasks such as transmitting communications, updating CRM records, or creating support tickets.

### 2. Method

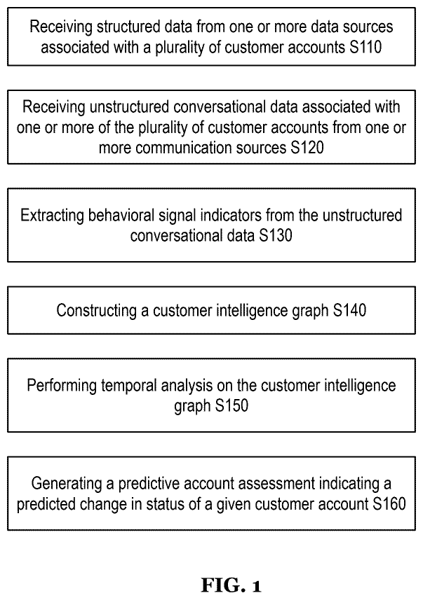

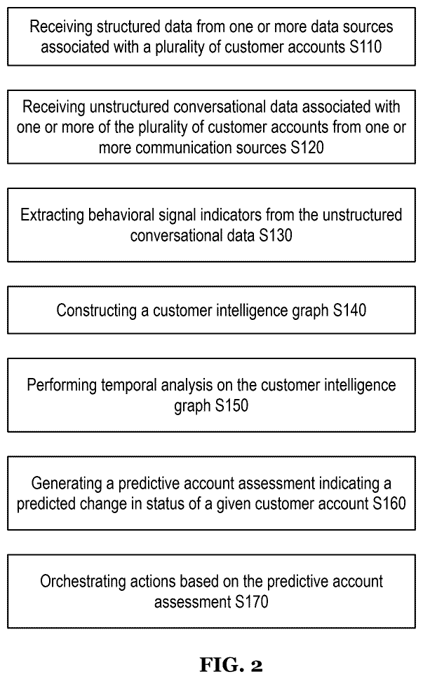

As shown in FIG. 1, a method for generating customer intelligence from structured and unstructured data may include: receiving structured data from one or more data sources associated with a plurality of customer accounts S110; receiving unstructured conversational data associated with one or more of the plurality of customer accounts from one or more communication sources S120; extracting behavioral signal indicators from the unstructured conversational data S130; constructing a customer intelligence graph S140; performing temporal analysis on the customer intelligence graph S150; and generating a predictive account assessment indicating a predicted change in status of a given customer account S160. In some variations, the method may further include orchestrating actions based on the predictive account assessment S170, as shown in FIG. 2.

In general, the method may receive structured data (e.g., timestamped customer activity records from CRM systems, data warehouses, product analytics platforms, and billing systems) and unstructured conversational data (e.g., meeting transcripts, email correspondence, support tickets, instant messages, and call recordings) and combine them into a unified customer intelligence graph. Such an intelligence graph may capture or characterize account entities and behavioral signal entities and how they may be linked by temporal relationships. The method may then perform temporal analysis on the customer intelligence graph to identify patterns (e.g., trends, correlations, and sequences among the temporal relationships) and generate predictive account assessments based on the identified patterns. The temporal analysis and the form of the predictive account assessment may vary depending on the application. For example, the temporal analysis may be adapted for churn prediction analysis, in which the method computes structured and unstructured scores and combines them into a composite predictive assessment. Alternatively, the temporal analysis may be adapted for customer journey analysis, in which the method analyzes sequential activity patterns and evaluates account progression through sequential stages.

In some variations, the method may be adapted specifically for customer journey analysis, which functions to understand how a customer transitions through stages of engagement. In such variations, performing temporal analysis on the customer intelligence graph S150 may include generating an event log of timestamped activity records from the customer intelligence graph for the plurality of customer accounts, and analyzing sequential activity patterns across the plurality of customer accounts to identify activity relationships among the timestamped activity records. The predictive account assessment generated at S160 may then be based on the identified activity relationships, as described below.

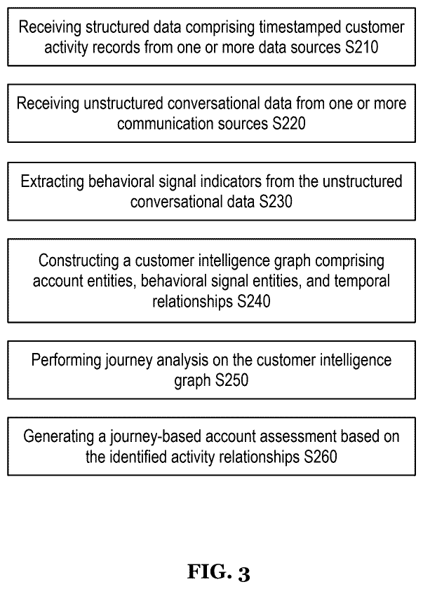

Accordingly, as shown in FIG. 3, a method for generating customer journey intelligence may include: receiving structured data comprising timestamped customer activity records from one or more data sources S210; receiving unstructured conversational data from one or more communication sources S220; extracting behavioral signal indicators from the unstructured conversational data S230; constructing a customer intelligence graph comprising account entities, behavioral signal entities, and temporal relationships S240; performing journey analysis on the customer intelligence graph, including generating an event log of timestamped activity records and analyzing sequential activity patterns to identify activity relationships S250; and generating a journey-based account assessment based on the identified activity relationships S260. Steps S210 through S240 may be variations of steps S110 through S140, respectively, and may include any suitable variation thereof described herein. Steps S250 and S260 are described in further detail in the Customer Journey Analysis application section below.

In some variations, the method may be adapted specifically for behavioral signal extraction and predictive scoring. This may be used for various use cases, but as one exemplary application would be the prediction and flagging of accounts at risk for churning (e.g., abandoning a product). This may be used for detecting positive, negative, or neutral tendencies of a customer. Herein, churn is used as an exemplary predicted behavior. However, other behaviors such as usage retention, growth, or other behaviors may additionally or alternatively be predicted. In such variations, extracting behavioral signal indicators S130 may include providing the trained language model with context information describing products or services of a vendor associated with the plurality of customer accounts, and/or classifying segments of the unstructured conversational data into one or more signal categories from a predefined signal taxonomy. The predictive account assessment generated at S160 may then be based on composite scoring that combines structured and unstructured scores, as described below.

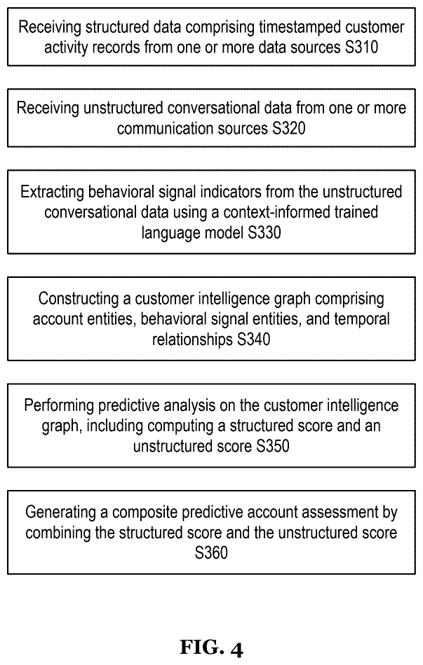

Accordingly, as shown in FIG. 4, a method for generating predictive customer intelligence from behavioral signals may include: receiving structured data comprising timestamped customer activity records from one or more data sources S310; receiving unstructured conversational data from one or more communication sources S320; extracting behavioral signal indicators from the unstructured conversational data using a context-informed trained language model, including classifying conversation segments into signal categories from a predefined signal taxonomy and associating each classified segment with a sentiment polarity value and one or more supporting text excerpts S330; constructing a customer intelligence graph comprising account entities, behavioral signal entities, and temporal relationships S340; performing predictive analysis on the customer intelligence graph, including computing a structured score and an unstructured score S350; and generating a composite predictive account assessment by combining the structured score and the unstructured score S360. Steps S310 through S340 may be variations of steps S110 through S140, respectively, and may include any suitable variation thereof described herein.

In any of the method variations described above, the method may further include orchestrating actions based on the predictive account assessment S170. Orchestrating actions may include generating, based on the predictive account assessment and a current state of the given customer account within the customer intelligence graph, one or more automated task recommendations for the given customer account. The automated task recommendations may be generated by a language model informed by customer success practices. In some variations, orchestrating actions may further include automatically executing one or more of the automated task recommendations via programmatic integration with one or more external systems (e.g., transmitting a communication to a customer contact, updating a record in a customer relationship management system, or creating a task in a project management or support system).

Block S110, which includes receiving structured data from one or more data sources associated with a plurality of customer accounts, functions to aggregate customer information and activity records into the customer intelligence system for downstream analysis. The structured data may include timestamped events, each associated with an activity identifier, an account identifier, and additional metadata describing the event.

The one or more data sources may include customer relationship management (CRM) systems (e.g., Salesforce), data warehouses, product analytics platforms (e.g., Segment, Pendo, Mixpanel), support ticketing systems, billing systems, business intelligence platforms, and/or other instrumentation systems. In some variations, the structured data may further include business intelligence data such as company financials, employee growth metrics, funding round data, stock performance, and intent data. The data sources may additionally include internal platform data (e.g., notes or comments) created by a user of the platform. Other exemplary data sources may include external data sources for business intelligences like news APIs/feeds, intent providers, data brokers, and/or other sources of relevant data. These sources may be customized for different accounts and/or customers. The structured data may be received from any suitable combination of these data sources.

The structured data may be received via one or more ingestion methods. In some variations, the structured data may be received via database queries (e.g., SQL queries executed against relational databases to extract relevant activity data). Alternatively or additionally, the structured data may be received via reverse ETL (extract, transform load process), in which data is extracted from data warehouses and transformed into a format suitable for processing by the customer intelligence system. In some variations, the structured data may be received via API calls (e.g., RESTful or GraphQL APIs used to fetch activity data from third-party applications). The structured data may additionally or alternatively be received via webhooks that notify the customer intelligence system in real time whenever an activity occurs, enabling near-real-time updates to the customer intelligence graph. In some variations, the structured data may be received via file uploads (e.g., batch data uploaded in CSV or JSON formats), and/or manually entered into a data system. In some variations, manual data entry may be used as a fallback when automated data collection is not feasible.

In some variations, receiving structured data may additionally include actively retrieving supplemental external data. This may use various automated data collection routines which may use existing data to fetch additional data. For example, based on the company name of a customer, a process routine may retrieve external data related to that company such as legal, financial, funding, product, team, and/or other types of data.

Each activity record in the structured data may be associated with a timestamp recording the time at which the activity occurred, which may be used to maintain temporal ordering of events for downstream temporal analysis at S150. The structured data may include various types of activity records, such as product usage events, subscription changes, support interactions, billing events, and account configuration changes.

Block S120, which includes receiving unstructured conversational data associated with one or more of the plurality of customer accounts from one or more communication sources, functions to ingest unstructured data such as conversational and textual data that may capture customer sentiment, behavioral observations, and relationship context not available in structured activity records.

The one or more communication sources may include meeting transcript services, email systems, instant messaging platforms (e.g., Slack), video conferencing recordings and transcripts (e.g., Zoom), customer support chat logs, voice call transcriptions, notes entered by sales or customer success teams, support tickets, and internal platform data generated by system users, such as account-specific task lists, internal collaboration comments, and annotations on customer timelines. In some variations, the communication sources may further include customer feedback mechanisms such as Net Promoter Score (NPS) surveys, Customer Satisfaction (CSAT) surveys, phone surveys, and/or online surveys. The unstructured conversational data may be received from any suitable combination of these communication sources.

The unstructured conversational data may be received via standard APIs provided by the communication platforms. For example, the customer intelligence system may connect to messaging platforms (e.g., Slack) or video conferencing platforms (e.g., Zoom) via their respective APIs to retrieve conversation content, including meeting summaries, full transcripts, and message text. In some variations, audio recordings may be transcribed to produce textual transcripts for analysis. In some variations, text may be extracted from images or documents associated with communications. In some variations, the unstructured data received at S120 may further include audio, visual, and/or video data from which contextual signals such as gestures, tone, and/or visual cues may be captured and characterized for downstream analysis.

The unstructured conversational data may be associated with one or more customer accounts via participant identifiers. For example, the customer intelligence system may examine participant email addresses from a meeting or message thread and associate the conversation with the corresponding customer account based on email domain or other identifying information. This multi-channel account association may enable the customer intelligence system to link conversations occurring across different communication channels to the same customer account, thereby providing a more complete view of customer interactions than any single communication source alone.

Block S130, which includes analyzing, by a trained language model, the unstructured conversational data to extract a plurality of behavioral signal indicators, functions to transform unstructured conversational data into structured, categorized behavioral observations that may be stored in the customer intelligence graph and used for downstream temporal analysis. In one variation, each behavioral signal indicator may include a categorization (e.g., a signal category from a predefined signal taxonomy) and a temporal attribute associated with a customer account (e.g., the date or time at which the underlying conversation occurred).

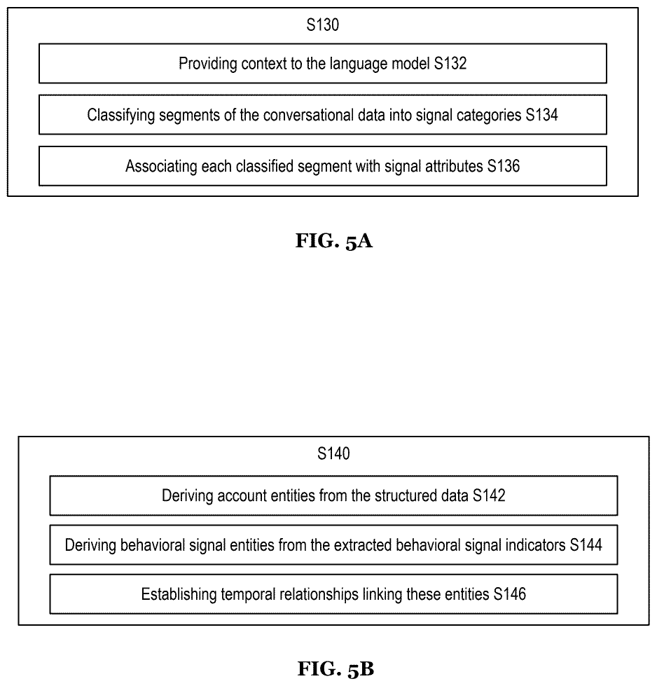

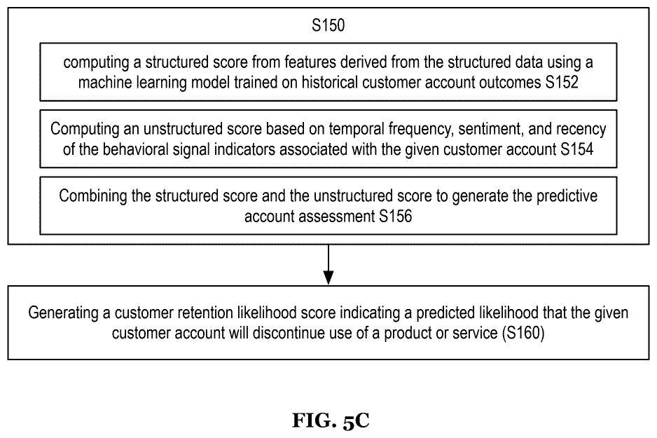

In some variations, the behavioral signal indicators may be referred to as needle movers, reflecting their role as key behavioral observations that may influence predictions of customer account status. The trained language model may analyze the unstructured conversational data to extract these behavioral signal indicators by performing one or more of: providing context to the language model S132, classifying segments of the conversational data into signal categories S134, and associating each classified segment with signal attributes S136, as shown in FIG. 5A.

As one example, the customer intelligence system may receive a meeting transcript in which a customer discusses pricing favorably and mentions a competitor product. The trained language model, informed by context about the vendor's products and competitive landscape S132, may classify relevant segments of the transcript into signal categories such as “pricing mention” and “competitor mention” from the predefined signal taxonomy S134. For each classified segment, the language model may associate a sentiment polarity value (e.g., positive for the pricing mention, negative for the competitor mention) and extract one or more supporting text excerpts from the transcript that justify each classification S136. These extracted behavioral signal indicators may then be stored in the customer intelligence graph as behavioral signal entities linked to the corresponding customer account.

Sub-step S132, which includes providing the trained language model with context information describing products or services of a vendor associated with the plurality of customer accounts, functions to inform the language model about the vendor's specific product domain so that the language model may accurately identify and classify behavioral signals within the conversational data.

Without context information, a general-purpose language model may lack the domain knowledge to distinguish relevant behavioral signals from noise within customer conversations. For example, if a vendor provides an accounting product and a customer mentions that “a bank account has been closed,” a language model without product context may misinterpret this as the customer canceling their account, when in fact the customer is discussing a bank account within the accounting product. As another example, when a customer discusses a feature request, a language model without knowledge of the vendor's product feature set may incorrectly classify unrelated topics as feature requests or may fail to recognize a genuine feature request. By providing the trained language model with context information (e.g., descriptions of the vendor's products, feature sets, common customer use cases, and relevant terminology), the customer intelligence system may enable the language model to pick out the nuances of what customers are discussing and to more accurately extract behavioral signal indicators from the unstructured conversational data.

The context information may be provided to the trained language model as part of a prompt that includes the conversational data and instructions for extraction, as shown in FIG. 11. In some variations, the context information may include product descriptions, feature lists, industry-specific terminology, known customer use cases, and other vendor-specific information that may help the language model distinguish relevant signals from irrelevant content.

Sub-step S134, which includes classifying, by the trained language model, segments of the unstructured conversational data into one or more signal categories from a predefined signal taxonomy, functions to categorize portions of conversational data into standardized behavioral categories that may be tracked and analyzed across customer accounts over time.

The predefined signal taxonomy may define a set of signal categories representing types of behavioral observations that are relevant to customer intelligence. For example, the signal categories may include pricing mentions, competitor mentions, feature requests, bug reports, expansion interest, executive engagement, product adoption feedback, support escalations, and other categories relevant to understanding customer behavior and sentiment. In some contexts, these signal categories may be referred to as content labels. The signal taxonomy may be predefined based on domain knowledge and customer success practices, and in some variations may be configurable by a user of the customer intelligence system to reflect vendor-specific categories.

The trained language model may analyze the unstructured conversational data segment by segment (e.g., by conversation, by message, or by topical section within a conversation) and classify each segment into one or more signal categories from the predefined signal taxonomy. A single conversation may yield multiple classified segments. For example, a customer meeting transcript may contain a pricing mention, a feature request, and a positive product adoption observation, resulting in three separate classified segments from the same conversation. The classified segments may then be transformed into a structured form suitable for storage in the customer intelligence graph and for use by the prediction models at S150.

Sub-step S136, which includes associating each classified segment with the signal category, a sentiment polarity value, and one or more supporting text excerpts extracted from the unstructured conversational data, functions to enrich each classified segment with attributes that may enable downstream scoring and analysis.

For each classified segment, the trained language model may associate the segment with a sentiment polarity value indicating whether the behavioral observation has a positive, negative, or neutral impact on the customer relationship. Other forms of sentiment analysis or sentiment classification may alternatively be used depending on implementation. In some variations, the trained language model analyzes the classified segment within the context of its associated conversation metadata to resolve ambiguity. The model may receive inputs including the conversation type (e.g., support ticket vs executive email), the thread history, and prior comments. For instance, the phrase ‘you can close this’ in a support ticket context is interpreted as a successful resolution (positive), whereas the same phrase in a contract renewal might be interpreted as account churn (negative). By conditioning the sentiment analysis on this conversational context, the system may reduce false positives in behavior signal extraction. The model may also receive “grounding” information, including the background of the company for which the analysis is being performed, details of their product or service offerings, examples of competitors, and the like. In another example, a pricing mention in which the customer states “the pricing looks good, we're going to sign the contract” may be associated with a positive sentiment polarity, while a pricing mention in which the customer expresses concern about cost may be associated with a negative sentiment polarity. The sentiment polarity value may be used at S150 to weight the behavioral signal indicators during temporal analysis.

For each classified segment, the trained language model may additionally extract one or more supporting text excerpts from the unstructured conversational data. The supporting text excerpts may include one or more sentences from the original conversation that justify the classification and sentiment assignment, providing traceability from the behavioral signal indicator back to the source conversational data. The supporting text excerpts may be stored in the customer intelligence graph alongside the behavioral signal entity and may be surfaced through the user interface module to enable users to review the basis for each extracted signal.

In some variations, the customer intelligence system may additionally generate vector embeddings at multiple levels of abstraction for the classified segments. A content embedding representing a semantic vector of the segment of unstructured conversational data may be generated to capture the raw conversational context. A signal embedding representing a semantic vector of the extracted behavioral signal indicator may be generated to capture the abstract categorical meaning of the detected signal. Both the content embedding and the signal embedding may be indexed in a vector index to enable semantic similarity retrieval based on either raw conversational context or extracted signal category. For example, the vector index may support granular semantic searches (e.g., finding similar conversation snippets) as well as high-level pattern matching (e.g., clustering accounts with semantically similar risk signals) independent of the specific phrasing used by the customer.

Block S140, which includes constructing a customer intelligence graph as shown in FIG. 5B, functions to unify the structured data received at S110 and the behavioral signal indicators extracted at S130 from unstructured data like conversation data into a single temporal graph data structure that may be queried and analyzed. The customer intelligence graph may include, characterize, or otherwise model (a) account entities derived from the structured data, (b) behavioral signal entities derived from the extracted behavioral signal indicators, and (c) temporal relationships linking the account entities and the behavioral signal entities across a time dimension

The customer intelligence graph may store entities representing customer accounts, users, activities, subscriptions, conversations, and behavioral signals, along with temporal relationships that link these entities across a time dimension. The collected data may be standardized to ensure consistency across different sources by mapping various data fields to a common schema. Each activity or event may be timestamped to record the time at which it occurred, and additional metadata (e.g., account identifier, user identifier, activity type) may be added to provide context. The construction of the customer intelligence graph may include deriving account entities from the structured data S142, deriving behavioral signal entities from the extracted behavioral signal indicators S144, and establishing temporal relationships linking these entities S146, as described below.

In some variations, the entities in the customer intelligence graph may conform to predefined entity type schemas comprising account models, user models, and activity models. The predefined entity type schemas may be configurable to map to heterogeneous data source schemas from the one or more data sources, thereby serving as a translation layer between the varied data sources and the unified graph structure. In some variations, constructing the customer intelligence graph may further include determining, based on the predefined entity type schemas, expected entity types for each customer account, and identifying data gaps where expected entity types are absent from the customer intelligence graph or where populated entity data exceeds a staleness threshold.

In some variations, block S130 may include performing data gap identification, which may happen during construction of the customer intelligence graph or at any suitable time. Based on the predefined entity type schemas, the system may determine what entity types are expected for each customer account (e.g., account data, user data, product usage activity, conversation data, support ticket data) and may identify data gaps where expected entity types are absent from the graph or where populated entity data exceeds a staleness threshold (e.g., data that has not been updated within a defined time period). For example, if the entity type schemas indicate that product usage data is expected for a given customer account but no usage activity records have been ingested, the system may flag this as a data gap. Similarly, if CRM data for a customer account has not been updated within a staleness threshold, the system may flag the data as potentially stale (e.g., a customer champion listed in the CRM may no longer hold that role, as indicated by more recent conversation data). The identified data gaps may be surfaced to users through the user interface module, so that users may understand what information is known, what is missing, and whether the available data is sufficient to support reliable predictions. In some variations, identified data gaps may be stored within the customer intelligence graph as explicit gap entities, each representing a specific deviation from a normative account health model. The normative account health model may be derived from the predefined entity type schemas and may specify the expected entity types, relationships, and property completeness for accounts at a given stage or account profile. Each gap entity may include a gap type identifying the nature of the missing or stale data, a reference to the expected entity type that is absent or stale, and a severity indicator reflecting the magnitude of the data deficiency. For example, gap entities may represent structural gaps such as the absence of a user entity assigned to a decision-maker or executive sponsor role within the account, the absence of recorded renewal-related activity within a defined window prior to a contract end date, the absence of a recorded quarterly business review within the expected recurrence period, or the absence of a product champion contact following a departure signal detected in conversation data. Unlike simple data-absence flags, gap entities encode semantic health deviations—the gap type captures what kind of health expectation was not met, not merely which data field is null—enabling downstream processes such as prediction scoring and action orchestration to reason about the account's structural completeness. Storing gap entities as first-class objects within the customer intelligence graph may enable downstream processes, including the predictive analysis at S150 and the orchestration at S170, to query and act on identified gaps directly. In some variations, the data gaps may be used to generate or alter a confidence indicator associated with the predictive account assessment at S160, such that predictions based on incomplete data may be accompanied by lower confidence scores or otherwise flagged. In some variations, the customer intelligence system may attempt to fill identified data gaps by triggering supplemental data retrieval (e.g., as described at S110) or by prompting users to provide missing information. In some variations, data gap identification may further include data cleaning operations such as removing duplicates, handling outliers using statistical methods (e.g., Z-score analysis), and ensuring data consistency through validation checks, which may improve the quality and reliability of data stored in the customer intelligence graph.

Sub-step S142, which includes deriving account entities from the structured data, functions to populate the customer intelligence graph with entities representing customer accounts, users, activities, and/or other structured data objects.

The account entities may be derived by mapping the structured data received at S110 into predefined entity type schemas. The predefined entity type schemas may include account models (e.g., representing customer organizations with attributes such as industry, size, subscription tier, and contract dates), user models (e.g., representing individual contacts within a customer organization with attributes such as role, email, and engagement history), and/or activity models (e.g., representing product usage events, support interactions, billing events, and other timestamped activities). The entity type schemas may be configurable, such that each vendor may configure the schemas to map to the specific fields and structures of their heterogeneous data sources (e.g., mapping CRM fields to account model properties, mapping product analytics events to activity model properties). This configurable mapping may function as a translation layer that enables the customer intelligence graph to integrate data from varied systems into a standardized entity representation.

The entity type schemas may be established and maintained through various approaches. In some variations, the customer intelligence system may provide predefined entity type schemas with standard properties expected for common entity types (e.g., standard account properties such as name, industry, and contract value; standard user properties such as role, email, and last activity date). In some variations, the entity type schemas may be automatically mapped to incoming data sources, wherein the customer intelligence system may analyze the structure of a connected data source and automatically map source fields to corresponding schema properties. In some variations, the entity type schemas may be user-configurable, such that a user of the customer intelligence system may define custom entity types, add or remove properties, and specify how fields from their specific data sources map to schema properties. In practice, the entity type schemas may be established through a combination of these approaches (e.g., the system may provide predefined schemas that are then automatically mapped where possible and further refined by user configuration).

Sub-step S144, which includes deriving behavioral signal entities from the extracted behavioral signal indicators, functions to populate the customer intelligence graph with stored representations of the categorized behavioral observations extracted at S130.

As described at S130, a behavioral signal indicator is an extracted behavioral observation produced by the trained language model, comprising a categorization (e.g., a signal category) and a temporal attribute associated with a customer account. By storing these behavioral signal indicators alongside the account entities derived from structured data at S142, the customer intelligence graph may uniquely combine structured data (e.g., product usage events, subscription records, support tickets) and unstructured data (e.g., behavioral observations extracted from conversations) into a single queryable data structure, thereby enabling temporal analysis that spans both data types.

Each behavioral signal indicator extracted at S130 may be stored in the customer intelligence graph as a corresponding behavioral signal entity (e.g., a graph node derived from the extracted indicator). The behavioral signal entity may alternatively be referred to or characterized as a record of the behavioral signal indicator stored within the intelligence graph. The behavioral signal entity may include the signal category, the sentiment polarity value and/or other model-derived qualitative assessment, the one or more supporting text excerpts, and the temporal attribute (e.g., the timestamp of the underlying conversation). In some variations, the behavioral signal entity may additionally include metadata about the source conversation, such as the conversation type (e.g., meeting, Slack message, email), participants involved, conversation duration, title, and a full meeting summary or transcript. The content labels extracted from the unstructured conversational data may thereby be transformed into a structured form within the customer intelligence graph that may be used by the prediction models at S150.

Sub-step S146, which includes establishing temporal relationships linking the account entities and the behavioral signal entities across a time dimension, functions to connect the entities in the customer intelligence graph such that the graph captures how customer accounts, users, activities, conversations, and behavioral signals relate to one another over time.

The temporal relationships may include various relationship types linking different entity types. For example, the temporal relationships may include user-to-account associations (e.g., linking a user entity to the customer account to which the user belongs), activity-to-account associations (e.g., linking a timestamped product usage event to the customer account that performed the activity), and signal-to-conversation associations (e.g., linking a behavioral signal entity to the conversation entity from which the signal was extracted). The temporal relationships may further include temporal orderings that capture the sequence in which activities and signals occurred for a given customer account.

Because each activity and behavioral signal entity may be attributed to an account and may have a timestamp, the customer intelligence graph may represent the full temporal history of each customer account's interactions, behaviors, and signals. This temporal structure may enable the system to look at events in aggregate across customer accounts and to identify patterns in the types and sequences of activities performed, as described at S150. In some variations, the temporal relationships may further capture relationships between entities from different data sources (e.g., linking a CRM record update to a meeting transcript that occurred on the same date), thereby bridging structured and unstructured data within the unified graph.

Block S150, which includes performing temporal analysis on the customer intelligence graph, functions to analyze the temporal structure of the customer intelligence graph to identify patterns that may be predictive of changes in customer account status. Performing the temporal analysis may be performed for a given customer account or any suitable entity, to identify a pattern among the temporal relationships between the account entities and the behavioral signal entities associated with the given customer account.

The temporal analysis may be adapted for various applications depending on the type of pattern to be identified and the form of prediction to be generated. In one variation, the temporal analysis may be adapted for churn prediction analysis, as shown in FIG. 5C, in which the method computes structured and unstructured scores from features and behavioral signal indicators within the customer intelligence graph, and combines them into a composite predictive assessment. In another variation, the temporal analysis may be adapted for customer journey analysis, as shown in FIG. 8, in which the method generates an event log and analyzes sequential activity patterns to identify activity relationships and evaluate account progression through sequential stages.

Block S150 is generally performed in connection with block S160, which includes generating, based on the identified pattern, a predictive account assessment indicating a predicted change in status of the given customer account, and which functions to produce an actionable output from the temporal analysis performed at S150. The form of the predictive account assessment may vary depending on the application. For example, when adapted for churn prediction analysis, the predictive account assessment may include a customer retention likelihood score, a confidence indicator, and/or feature contribution analysis. When adapted for customer journey analysis, the predictive account assessment may include an account progression label (e.g., on-time, progressing slowly, or stalled) based on the account's position within sequential stages.

Blocks S150 and S160 may be adapted for churn prediction analysis, as shown in FIG. 5C. In such a variation, performing temporal analysis at S150 may include computing a structured score from features derived from the structured data using a machine learning model trained on historical customer account outcomes S152, computing an unstructured score based on temporal frequency, sentiment, and recency of the behavioral signal indicators associated with the given customer account S154, and combining the structured score and the unstructured score to generate a composite assessment S156; and generating a predictive account assessment at S160 may include interpreting the composite assessment to generate a customer retention likelihood score indicating a predicted likelihood that the given customer account will discontinue use of a product or service within a defined future time period. In some variations, the churn prediction analysis may alternatively be framed as S152, S154, and S160, wherein the combining of scores is performed as part of S160 rather than as a separate sub-step S156. In some variations, the temporal analysis may further include weighting the behavioral signal indicators and the account entities based on temporal recency, such that more recent data contributes more heavily to the identified pattern.

Sub-step S152, which includes computing a structured score from features derived from the structured data using a machine learning model trained on historical customer account outcomes, functions to generate a quantitative score reflecting the predicted account status based on structured data patterns.

The structured score may be computed by first deriving features from the structured data stored in the customer intelligence graph. The features may include activity frequency metrics (e.g., count of activities within 30 days, count within 6 months), activity count aggregations, account trait values (e.g., industry, region, subscription tier), and computed metrics (e.g., interaction frequency, support ticket volume trends). Data preprocessing may include calculating summary statistics to provide context, treating missing values as a count of zero to avoid bias, normalizing values (e.g., log scaling for high-frequency activities), and applying regularization (e.g., lasso or ridge) to handle multi-collinearity and prevent overfitting. In some variations, penalty terms may be introduced for certain factors to adjust the influence of specific features based on business rules or domain knowledge. In some variations, feature engineering may create new features from raw data, such as interaction frequency metrics and sentiment score aggregations. Feature selection may include correlation analysis (e.g., Pearson or Spearman correlation coefficients), importance ranking (e.g., using Random Forest or XGBoost), and dimensionality reduction (e.g., Principal Component Analysis).

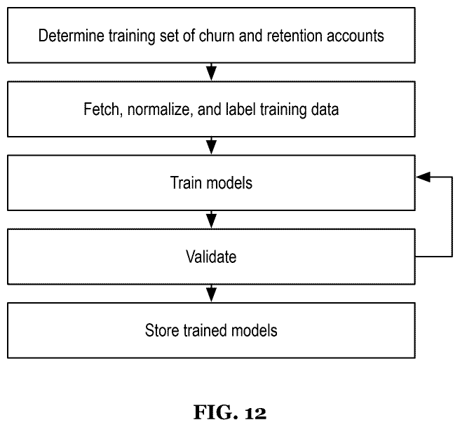

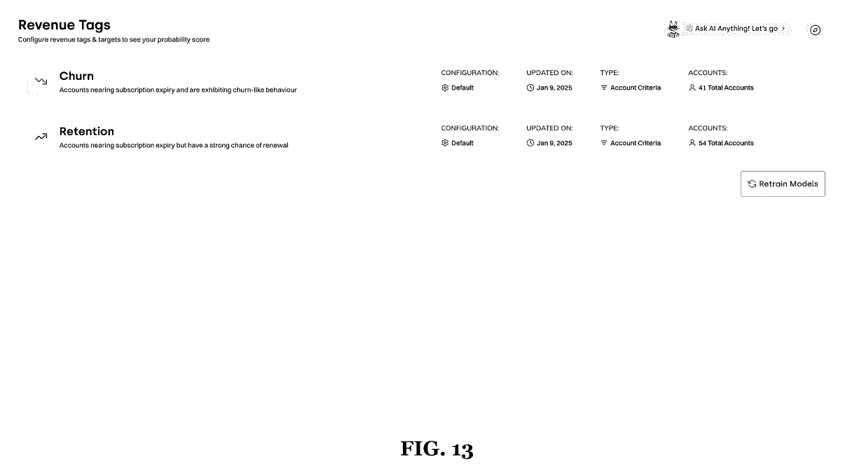

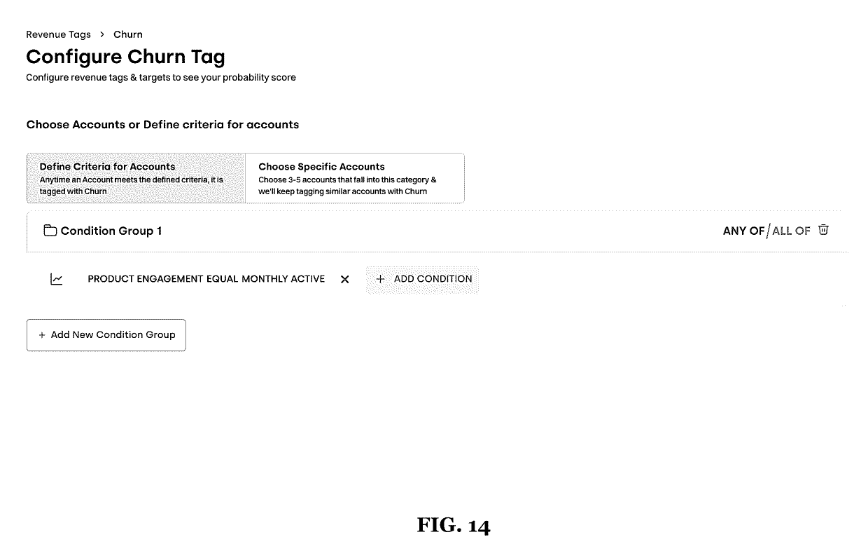

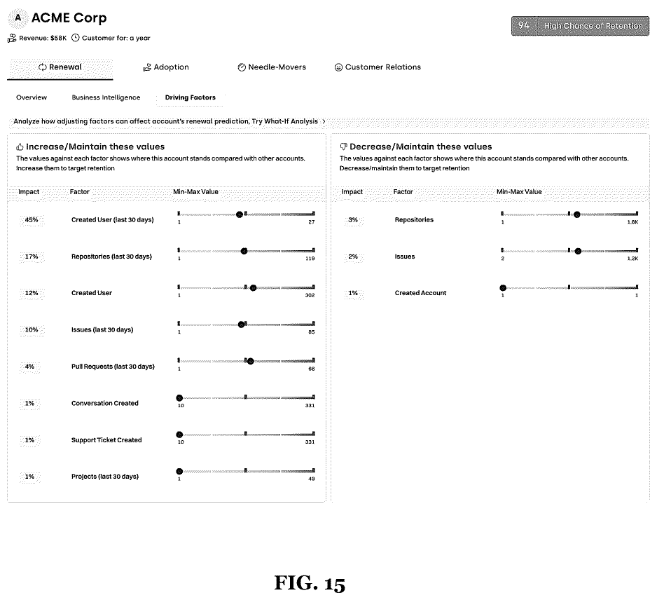

The machine learning model may be trained via a prediction model training pipeline, as shown in FIG. 12. The training pipeline may include: determining a training set by identifying customer accounts labeled as churned or retained; fetching, normalizing, and labeling the training data; training one or more machine learning models on the labeled data; validating the trained models against a validation dataset; and storing the trained models for use in prediction. The validation step may iterate back to the training step to refine model parameters until performance thresholds are met. Churn labels may be assigned based on known churn events using timestamps from CRM systems or manual annotations. In some variations, account tags used for training may be configured via a user interface that allows users to define churned and retained accounts based on filter criteria, as shown in FIGS. 13-14. The machine learning model may include one or more of: logistic regression, random forest, decision tree, support vector machine, neural network, or an ensemble of multiple model types. Hyperparameter tuning may optimize model parameters using techniques such as grid search or random search with cross-validation. Model performance may be evaluated by backtesting predictions against historical customer account outcomes, using metrics such as accuracy, precision, recall, F1 score, and AUC-ROC.

In some variations, the structured score may be based on an ensemble of multiple machine learning models, in which the structured score is a weighted average of the predictions from the multiple models, with weights determined by each model's performance on a validation dataset.

Sub-step S154, which includes computing an unstructured score, functions to generate a quantitative score reflecting the predicted account status based on behavioral observations extracted from unstructured conversational data. In some variations, the unstructured score may be based on temporal frequency, sentiment, and/or recency of the behavioral signal indicators associated with the given customer account.

The unstructured score may be computed by aggregating the behavioral signal indicators (sometimes referred to as needle movers) associated with the given customer account over a defined time period. The aggregation may be based on the frequency of behavioral signal indicators (e.g., how often signals of a given category have been observed), the sentiment polarity values associated with the signals (e.g., the proportion of positive versus negative signals), and the temporal recency of the signals (e.g., more recent signals may be weighted more heavily than older signals). In some variations, the unstructured score may be computed as a weighted sum based on signal category, sentiment polarity, and temporal recency, such that signals in categories with greater predictive importance, signals with stronger sentiment, and more recent signals contribute more heavily to the score. In some variations, if available, the method may incorporate contextual signals from different mediums such as audio, visual, and/or video, which may be used to additionally incorporate gestures, tone, visual cues, and/or other unstructured signals to enhance the analysis.

In some variations, computing the unstructured score may further include weighting the behavioral signal indicators and the account entities based on temporal recency, such that more recent data contributes more heavily to the identified pattern. This temporal recency weighting may reflect the observation that recent customer interactions and behavioral signals may be more indicative of current account status than older interactions.

Sub-step S156, which includes combining the structured score and the unstructured score to generate the predictive account assessment, functions to produce a composite assessment that reflects both the structured data patterns and the unstructured behavioral signal patterns for the given customer account.

The composite assessment may be generated by combining the structured score computed at S152 and the unstructured score computed at S154. In some variations, the structured score and the unstructured score may be combined using a weighted formula, where the weights may be determined based on the relative predictive performance of each score or based on data availability for the given customer account. In some variations, the composite assessment may be computed as a mathematical combination of the structured score and the unstructured score (e.g., a weighted sum, a difference, or other suitable combination function).

In some variations, the systems and methods may be designed to operate effectively with unstructured data alone when structured data is missing or unavailable, and vice versa. For example, if product usage data is not available for a given customer account, the composite assessment may rely more heavily on the unstructured score derived from behavioral signal indicators. This adaptability may enable the systems and methods to generate predictive account assessments even when data from one path is incomplete.

In some variations, the churn prediction analysis may alternatively be framed as comprising S152, S154, and S160, wherein the combining of the structured score and the unstructured score is performed as part of generating the predictive account assessment at S160 rather than as a separate sub-step S156. In such variations, S160 may receive the structured score from S152 and the unstructured score from S154 and may combine and interpret the scores to generate the predictive account assessment. The systems and methods described herein may be practiced with or without S156 as a distinct sub-step.

When adapted for churn prediction analysis, generating a predictive account assessment at S160 may include interpreting the composite assessment generated at S156 to produce a customer retention likelihood score indicating a predicted likelihood that the given customer account will discontinue use of a product or service. In some variations, this prediction may be provided as a prediction for a defined future time period. While S156 computes the composite score by combining the structured and unstructured scores, S160 may further process this composite score to generate the full predictive account assessment, which may include additional analysis and output elements. In this variation, the structured score may alternatively be referred to as a retention score, and the unstructured score may alternatively be referred to as a churn score.

In some variations, the predictive account assessment may further include a confidence indicator generated based on completeness of data populated in the customer intelligence graph relative to the expected entity types for the given customer account. For example, if usage data is not available for a given account, the confidence indicator may reflect that the prediction is based on incomplete data, enabling users to evaluate the reliability of the assessment.

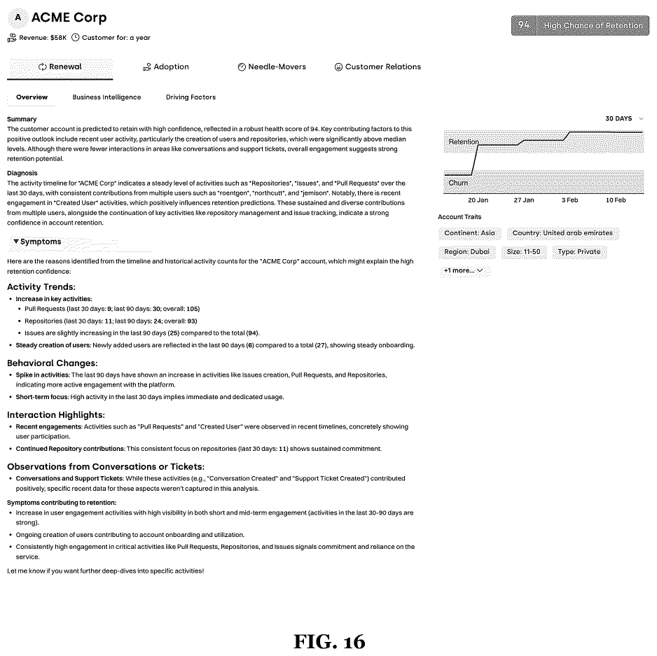

In some variations, generating the predictive account assessment may further include performing feature contribution analysis, in which the system identifies which features (e.g., specific activity metrics, behavioral signal categories, account traits) contributed most to the predicted assessment for the given customer account. The feature contribution analysis may present an overview of features to increase or maintain for the given customer account, as shown in FIG. 15. In some variations, the predictive account assessment may further include a language model generated analysis presenting a report including a generated written summary, a history of retention and churn prediction values, activity trends, behavioral changes, interaction highlights, and observations from conversations or tickets, as shown in FIG. 16. The feature contribution analysis may enable users to understand the reasoning behind a prediction and to identify specific areas for intervention.

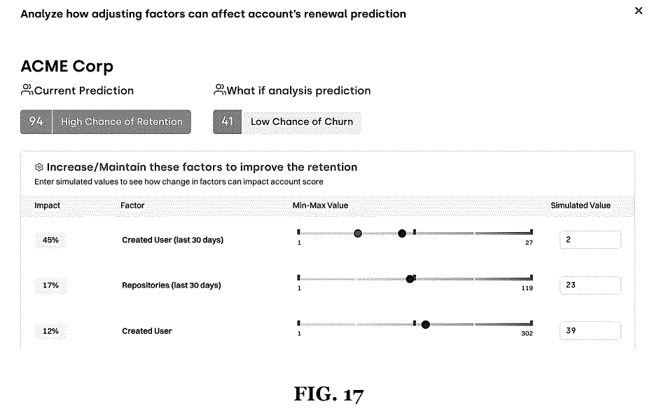

In some variations, generating the predictive account assessment may further include performing simulated outcome analysis (sometimes referred to as what-if analysis), in which the system models how changes to specific input variables (e.g., increased product usage, additional executive engagement, resolution of support tickets) may affect the predicted account status, as shown in FIG. 17. The simulated outcome analysis may be rendered via a user interface as a hypothetical scenario playground that enables users to plan how to change customer experiences by adjusting input variables and observing the predicted effects on account status. The simulated outcome analysis may enable users to evaluate potential intervention strategies before taking action. In some variations, the predictive account assessment may be structured as a state vector comprising the account's current feature values, behavioral signal attributes, and temporal trajectory indicators. When structured as a state vector, the predictive account assessment may serve as a baseline state representation suitable for input to downstream simulation or scenario planning processes, wherein one or more components of the state vector are modified to model hypothetical future account states and evaluate the effect of potential changes on predicted account status.

In some variations, generating the predictive account assessment may further include generating a narrative explanation using a language model, in which the system produces a natural language summary describing the key factors contributing to the predicted account status, the confidence level of the prediction, and recommended actions.

In some variations, the system may include a machine learning cluster analysis component that discovers similar accounts based on various features such as interaction patterns, sentiment scores, and demographic information. Users may compare accounts to understand differences in prediction factors, to understand why predictions differ for seemingly similar accounts, and to receive suggestions on actions that may improve account health.

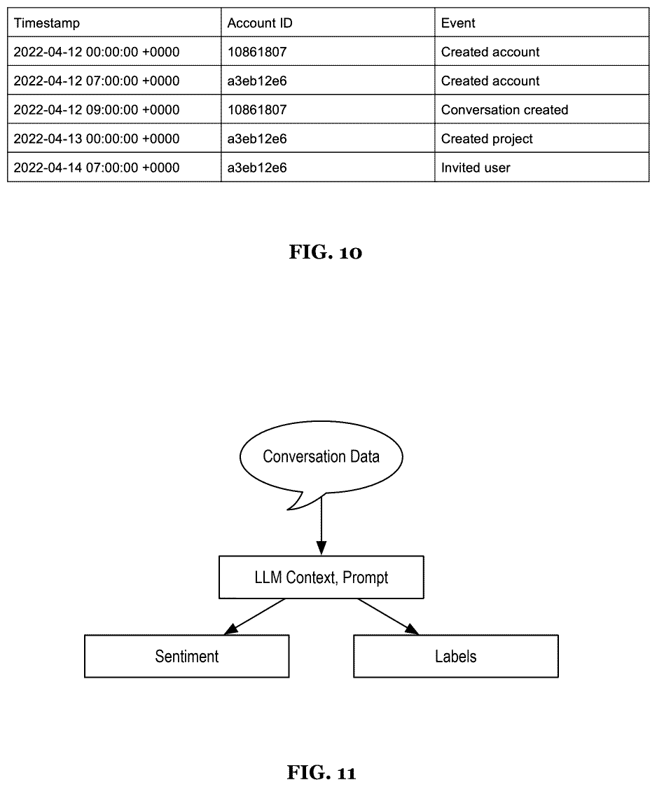

When adapted for customer journey analysis, performing temporal analysis at S150 may include generating an event log of timestamped activity records from the customer intelligence graph for the plurality of customer accounts, as shown in FIG. 10, and analyzing sequential activity patterns across the plurality of customer accounts to identify activity relationships among the timestamped activity records. This form of temporal analysis may use sequential pattern analysis techniques (sometimes referred to as process mining) to examine an event log of activities across different accounts and identify how activities relate to one another.

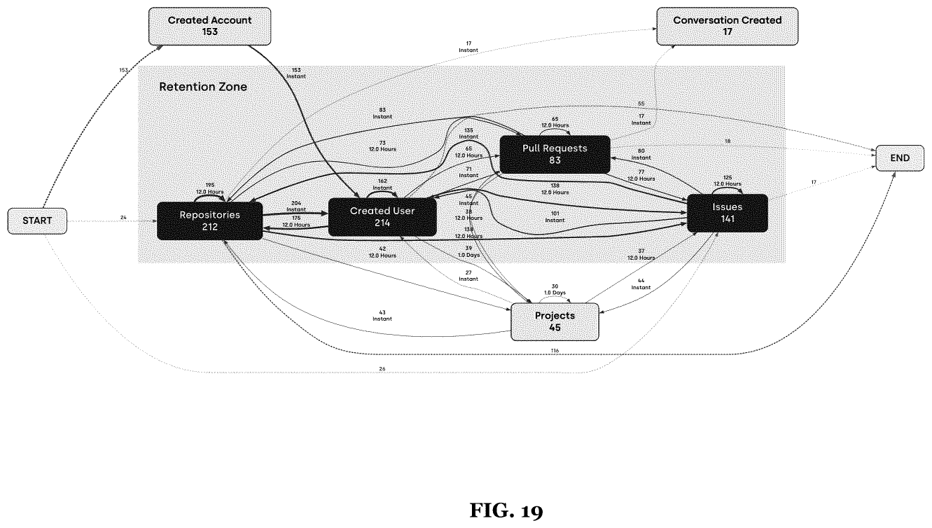

The event log may be generated by compiling the timestamped activity records from the customer intelligence graph into a structured log, where each entry represents an individual activity associated with a customer account and a timestamp. The activities can represent product usage activities, conversations, derived records (e.g., competitor mention derived from analysis of the text of a meeting), customer subscription lifecycle events (e.g. renewal, expansion, churn), and/or other activities or events. The event log may be converted into various data structures (e.g., Directly-Follows Graphs, Petri Nets, Heuristics Nets, Markov Chains) that may be used to generate a customer journey map showing a directed flow of activities with multiple potential paths, as shown in FIG. 19. The customer journey map may depict activity relationships, journey paths, journey durations, loops, and retention zones, and may be analyzed to determine metrics such as average or median time between paths, shortest and longest journey times, and segments with the best journey outcomes.

Analyzing sequential activity patterns may include identifying one or more of: prerequisite activities that precede other activities (e.g., if one activity always happens before another, it may be a prerequisite), parallel activities that may occur in any order (e.g., concurrent or independent activities), and cyclical activities that are performed repeatedly (e.g., activities that customers perform on a recurring basis after initial onboarding). For example, when setting up an email product, a customer may create an account, set up a signature, and customize a theme as onboarding activities, after which the customer may repeatedly read and send emails as cyclical activities.

In some variations, the temporal analysis may further include analyzing activity patterns of customer accounts identified as successful to identify a set of recurring activities correlated with sustained customer engagement. These recurring activities may define a retention zone (sometimes referred to as the point at which customers have adopted the product and continue to derive value from it). The retention zone may be calculated using machine learning techniques, wherein the system iterates through various possibilities to identify criteria that accurately reflect the behaviors of the most engaged customers. The identified set of recurring activities may be used as benchmark criteria for evaluating whether other customer accounts have achieved sustained product value. For example, if successful accounts consistently perform a particular set of activities on a recurring basis, accounts that have not yet exhibited those activities may be identified as not yet having achieved full product adoption.

In some variations, the temporal analysis may further include path analysis (identifying stages where a significant number of customers drop off), time-based analysis (identifying stages where customers spend an unusually long time before dropping off), and event sequence analysis (examining sequences of events leading up to a drop-off to identify specific activities or combinations of activities that precede a drop-off). For example, in a B2B context, the system may identify drop-off points in stages such as signup, inviting users, creating a project, and adding integrations.

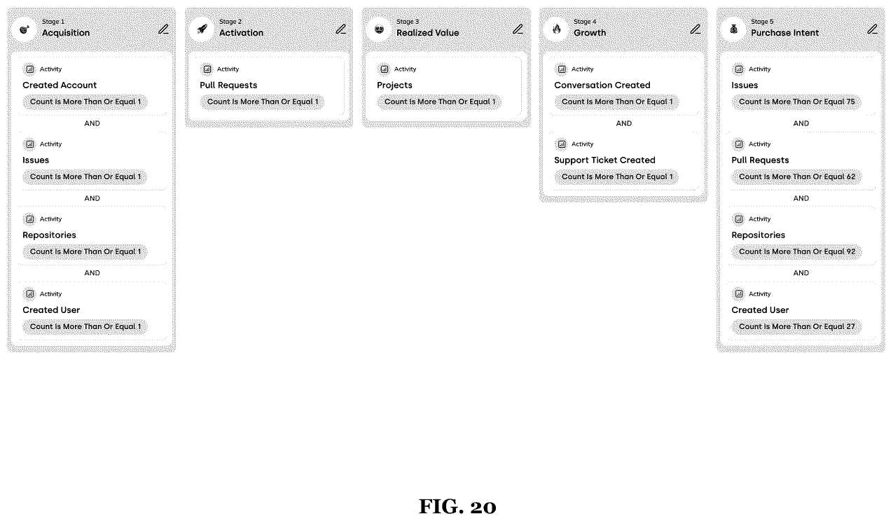

When adapted for customer journey analysis, generating a predictive account assessment at S160 may include defining a plurality of sequential stages based on the identified activity relationships, wherein each stage is associated with one or more gating conditions specifying activities that must be completed to advance to a subsequent stage. For example, a journey may be configured with a first stage requiring a particular activity to be completed a specified number of times, a second stage requiring two different activities to be completed, and a third stage requiring another activity to be completed, as shown in FIG. 20. The gating conditions may be derived from the journey map produced by the temporal analysis at S150, and in some variations may be further configurable by a user.

The method may further include evaluating, using a state machine, progression of each customer account through the plurality of sequential stages by replaying the timestamped activity records for each customer account against the gating conditions to determine a current stage for each customer account. The state machine may work by initializing the state of each stage and condition for each account, then replaying the event log events for each account through the state machine, which evaluates the conditions as if the time were the time specified by the event. As new events are input to the state machine, it may keep track of which conditions have been completed and update the stage state accordingly. At the end of the process, the state machine may determine where the account is in the journey and how long it was in each stage.

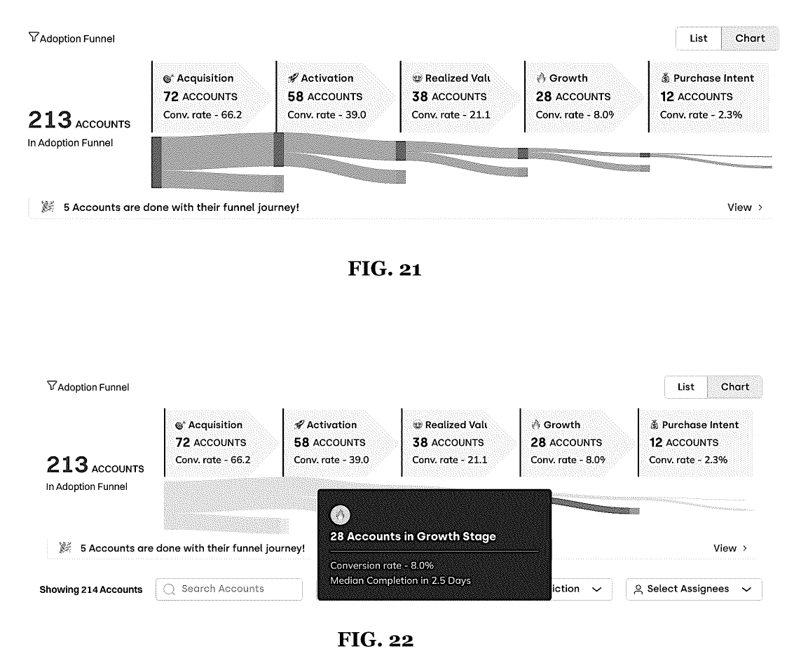

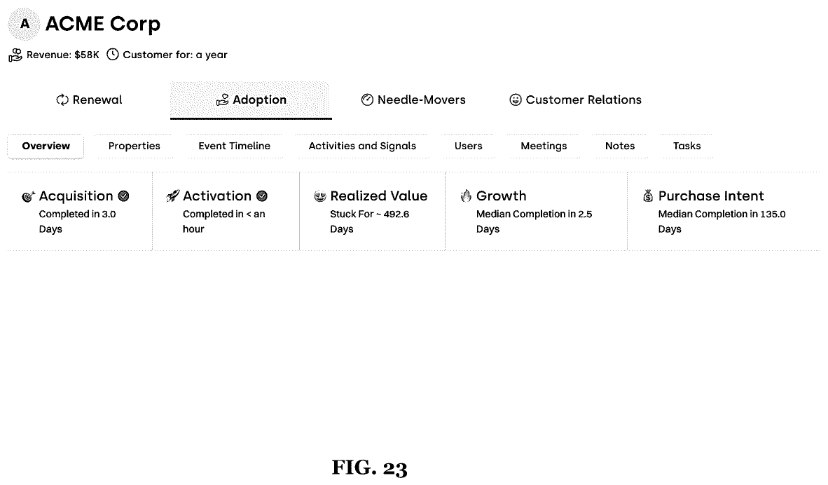

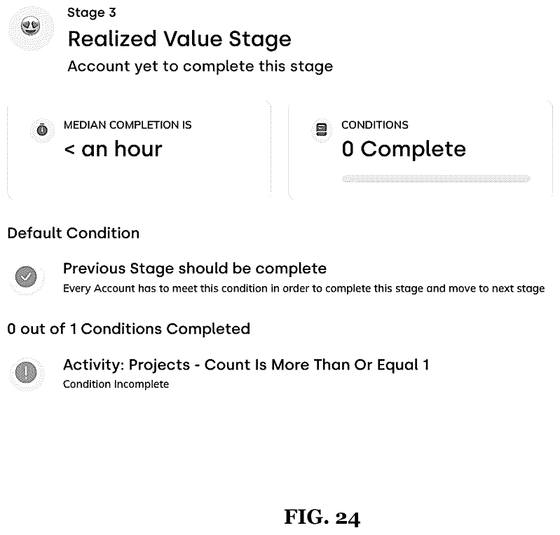

The method may further include labeling each customer account as one of on-time, progressing slowly, or stalled, based on comparison of the customer account's duration in a current stage to a historical stage duration metric. Stage progression may be visualized as a funnel showing how accounts flow from acquisition through activation, realized value, growth, and purchase intent, with the account distribution across sequential stages displayed as shown in FIG. 21. The funnel visualization may enable users to inspect individual stages, displaying the number of accounts at each stage, conversion rate between stages, and median completion time for each stage, as shown in FIG. 22. In some variations, the progression status for an individual customer account may be displayed as individual account stage detail showing which funnel the account is in, which stage of the funnel the account is in, how long the account has been in the current stage, and how long the account took to clear any previous stages, as shown in FIG. 23. For any stage, the individual account stage detail may show, based on historical data for the stage, the account's performance label indicating whether the account is progressing fast, on-time, slow, or stuck. The individual account stage detail may further include gating condition status and historical comparison data showing how the account's progression compares to historical metrics, as shown in FIG. 24. In some variations, “on-time” may be defined as a stage duration less than or equal to the median completion time for that stage across historical accounts, “progressing slowly” may be defined as a stage duration greater than the median, and “stalled” may be defined as a stage duration exceeding a multiple of the median (e.g., three times the median). In some variations, users may configure custom stage duration thresholds to override the default historical metrics. These labels may provide insights into account performance and may be used to identify trends, evaluate customer journeys, and inform corrective actions for accounts that are progressing slowly or stalled.

In some variations, the journey analysis may be designed to constantly update with new data and may be queryable. Results from queries may be used to power a user interface that retrieves all accounts by stage. The system may emit changes to accounts, such as stage transitions, label updates, and completion of conditions, which may be sent back to origin systems such as CRMs. In some variations, the system may segment customers based on various attributes (e.g., demographics, behavior, purchase history) to provide personalized journey maps. In some variations, the journey analysis may be visualized as a journey map, as shown in FIG. 19, depicting activities, journey paths, journey durations, loops, and retention zones.

Block S170, which includes orchestrating actions based on the predictive account assessment, functions to translate the predictions and assessments generated at S150 and S160 into actionable outputs that may be delivered to users, executed programmatically, or both. S170 may be an optional step that may be applied in connection with any of the method variations described herein (e.g., churn prediction analysis, customer journey analysis, or the primary method). The orchestration may include generating automated task recommendations, executing actions via external systems, employing agents with varying levels of autonomy, validating instructions through guardrails, exporting assessments, emitting changes to external systems, sending real-time alerts, performing outcome analysis, and incorporating user feedback for continuous improvement.

The orchestration at S170, including any autonomous software agents employed during orchestration, may operate on pre-computed analysis results that have been generated and stored as first-class properties within the customer intelligence graph during the preceding pipeline steps. As described at S130, the trained language model may analyze unstructured conversational data to extract and classify behavioral signal indicators, which are stored as behavioral signal entities within the graph at S144. As described at S150, one or more machine learning models may compute structured scores from features derived from structured data (e.g., product usage metrics, support ticket patterns, billing events), and the trained language model may compute unstructured scores based on the temporal frequency, sentiment, and recency of behavioral signal indicators. In some variations, the system may further perform cohort analysis to identify clusters of accounts with similar behavioral patterns and may perform anomaly detection to identify accounts exhibiting activity patterns that deviate from expected norms (e.g., sudden drops in product usage, atypical support ticket volumes, or behavioral signal patterns inconsistent with historical account behavior). These analysis results including behavioral signal classifications, machine learning scores, cohort membership labels, and anomaly indicators, may be computed during the data enrichment and analysis pipeline (e.g., at S130, S140, S150, and S160) and stored as queryable properties of the corresponding entities within the customer intelligence graph, such that the orchestration at S170 may query and act upon pre-enriched, pre-analyzed account data. This architectural approach may enable the orchestration module and any autonomous software agents to make decisions and generate actions based on the full depth of analytical results already materialized in the graph, rather than performing raw data analysis at orchestration time.

Orchestrating actions may include generating, based on the predictive account assessment and a current state of the given customer account within the customer intelligence graph, one or more automated task recommendations for the given customer account. For example, when the predictive account assessment indicates that a customer account is at risk of churning, the system may generate task recommendations such as scheduling a meeting with the customer, sending an outreach email, creating a support ticket, or assigning an account review to the Customer Success Manager. When the journey analysis indicates that an account is stalled at a particular stage, the system may generate task recommendations to nudge the account toward completing the gating conditions for the next stage (e.g., sending product materials, scheduling onboarding sessions, or prompting the customer to complete a specific activity). The task recommendations may be context-aware, taking into account the customer's current state, recent interactions, behavioral signal indicators, and stage progression when generating recommendations.

In some variations, the orchestration may be event-driven, such that actions are triggered when specified conditions are met. For example, a workflow may be configured such that sign up plus seven days without completing a specific activity triggers an automated email, or renewal date minus 90 days triggers a task for the account owner to start the renewal process. These deterministic, programmatic workflows may be configured by users to define orchestration rules based on temporal conditions, account states, and predicted outcomes.

In some variations, the automated task recommendations may be generated by a language model informed by customer success practices. The language model may be trained on industry best practices and may generate customer-specific, intelligent, actionable tasks based on the predictive account assessment and the current state of the customer account. For example, the language model may draft a personalized outreach email, generate meeting preparation notes summarizing the customer's recent activity (e.g., action items from prior meetings, open support tickets, recent behavioral signals), or compose a recommendation for next steps tailored to the customer's situation.

In some variations, orchestrating actions may further include automatically executing one or more of the automated task recommendations via programmatic integration with one or more external systems. As examples, executing may include one or more of: transmitting a communication to a customer contact (e.g., sending an email or instant message), updating a record in a customer relationship management system (e.g., updating a churn risk score, account status, or contact information in Salesforce), creating a task in a project management or support system (e.g., creating a support ticket, opening a bug report to an internal engineering team), scheduling a meeting, or following up on previously completed tasks.

In some variations, the system may support varying levels of autonomy for orchestrated actions. At lower levels of autonomy, the system may generate task recommendations that are presented to a human user for review and manual execution (e.g., drafting an email that a user reviews before sending). At higher levels of autonomy, the system may employ AI agents that automatically execute tasks without human intervention (e.g., automatically reaching out to champions on an account, setting up meetings, and scheduling them for the CSM). In some variations, the level of autonomy may be configurable by the user.

The orchestration may employ one or more agent types depending on the task and the desired level of autonomy. In some variations, a UI agent may present recommendations, preparation notes, and suggested actions through a user interface for human review and execution. In some variations, an autonomous backend agent may automatically execute workflow actions (e.g., sending emails, updating CRM records, creating support tickets) without human intervention. In some variations, a hybrid agent may combine automated execution with human review (e.g., generating a report or analysis that is reviewed by a human before further action is taken). The agent types may share a common agent core that receives approved instructions from an instruction validation pipeline.

In some variations, one or more autonomous software agents may execute a multi-step workflow based on the customer intelligence graph and the predictive account assessments. Unlike single-step task execution (e.g., sending one email or updating one CRM record), a multi-step workflow may involve a sequence of interdependent actions in which each step may depend on the outcome of a prior step. The multi-step workflow may include two or more steps selected from: retrieving information from the customer intelligence graph or one or more external systems; generating content (e.g., drafting an email, composing a report, or preparing meeting notes) based on the retrieved information; transmitting communications to external parties based on the generated content; processing inbound responses or events and updating the workflow state based on received information; performing a conditional action based on an intermediate result (e.g., escalating to a different agent or adjusting the workflow path based on a customer response); and, optionally, awaiting confirmation from a human user before executing a subsequent step.

In some variations, the autonomous software agent may maintain a persistent record of prior agent actions and external responses to inform subsequent steps. The persistent record may function as a memory that enables the agent to maintain context across multiple interactions with the same customer account over time, such that the agent may reference prior outreach attempts, customer responses, and intermediate outcomes when determining subsequent actions. This persistent memory may be stored within or in association with the customer intelligence graph, enabling the agent's interaction history to be queryable alongside other account data. For example, an autonomous software agent handling a renewal workflow may retrieve account health data and recent behavioral signals from the customer intelligence graph, generate a personalized renewal outreach email referencing the account's specific usage patterns and recent conversations, transmit the email to the customer contact, process the customer's response upon receipt, and take a follow-up action (e.g., scheduling a meeting if the customer expressed interest, or adjusting a discount offer if the customer raised pricing concerns) based on the response with each step informed by the outcomes of prior steps and subject to configurable guardrails.

In some variations, orchestrating actions may include an instruction validation pipeline, which functions to ensure that proposed actions generated by the language model or agents are accurate, appropriate, and/or consistent with prior interactions and/or with guidelines before they are executed. The instruction validation pipeline may include an LLM reasoning component that generates proposed instructions based on the predictive account assessment, contextual filters, and entity context from the customer intelligence graph. The proposed instructions may then be evaluated by output guardrails that check the proposed actions against predefined constraints (e.g., ensuring that a discount does not exceed a maximum threshold, or that a proposed communication is appropriate for the customer's situation). If a proposed instruction fails the guardrails, it may be returned to the LLM reasoning component for revision, elevated for human user review, and/or addressed in any suitable way.

In some variations, the instruction validation pipeline may further include a consistency verifier that checks proposed actions for consistency with prior actions and existing records. For example, if one agent has already presented a customer with a pricing quote, the consistency verifier may ensure that a subsequent agent does not generate a conflicting quote. Instructions that pass both the output guardrails and the consistency verifier may be approved and routed to the appropriate agent type for execution.

In some variations, orchestrating actions may further include exporting the predictive account assessment to one or more external systems. The assessment may be exported to a CRM system (e.g., Salesforce, Gainsight, or other customer success platforms), delivered via API notification, or published to a reporting dashboard. The export may be automated or manual, performed in bulk or for individual results, and may be scheduled or triggered by changes in predictions. This may ensure that sales and customer success teams have the most up-to-date information to make informed decisions.

In some variations, the system may emit changes to accounts (e.g., stage transitions, label updates, completion of conditions, updated churn risk scores) back to origin systems such as CRMs, ensuring that external systems have up-to-date information. The emitting of changes may be triggered automatically when the customer intelligence graph is updated or when the predictive account assessment changes.

In some variations, orchestrating actions may further include sending real-time alerts to stakeholders when the predictive account assessment crosses a defined threshold. For example, the system may send an alert when a churn risk score exceeds a critical threshold, when a high number of accounts enter a stalled stage, or when a behavioral signal indicator of a specified category is detected for a high-value account. The alerts may be delivered via email, instant message, in-app notification, or other communication channels.

In some variations, orchestrating actions may further include incorporating user feedback to refine the predictive models and task recommendations over time. Users may provide feedback on the predictions (e.g., through a confirmation or rejection mechanism such as a thumbs-up or thumbs-down control), and this feedback may be used to further refine the model in subsequent training iterations. In some variations, user feedback may also correct factual information in the customer intelligence graph. For example, if an agent recommends sending a renewal email to a specific contact, but a human user indicates that the contact is no longer at the company, the system may update the customer intelligence graph to reflect this corrected information, ensuring that subsequent predictions and recommendations are based on accurate data.

In some variations, the system may track prediction accuracy by comparing predictive account assessments against actual customer account outcomes. For example, if a prediction indicates churn and the account subsequently churns, it may be classified as a true positive; if the prediction indicates retention but the account churns, it may be classified as a false negative. This feedback may be used to improve the model in the next training iteration. The performance of the models may be tracked over time to ensure continuous improvement. In some variations, the LLM-generated analysis may similarly support a user feedback mechanism, allowing the language model outputs to be refined with human input over time.

In some variations, orchestrating actions may further include performing outcome analysis, in which the results of executed actions (e.g., whether an outreach email led to a customer response, whether a recommended intervention improved an account's health score, or whether a scheduled meeting occurred) are analyzed and fed back into the customer intelligence graph. This outcome analysis may enable the system to learn from the results of prior orchestrated actions and to adjust future recommendations accordingly. The outcome analysis may update the customer intelligence graph with the results of executed actions, creating a feedback loop in which the system continuously learns and adjusts its orchestration logic based on observed outcomes.

### 3. System

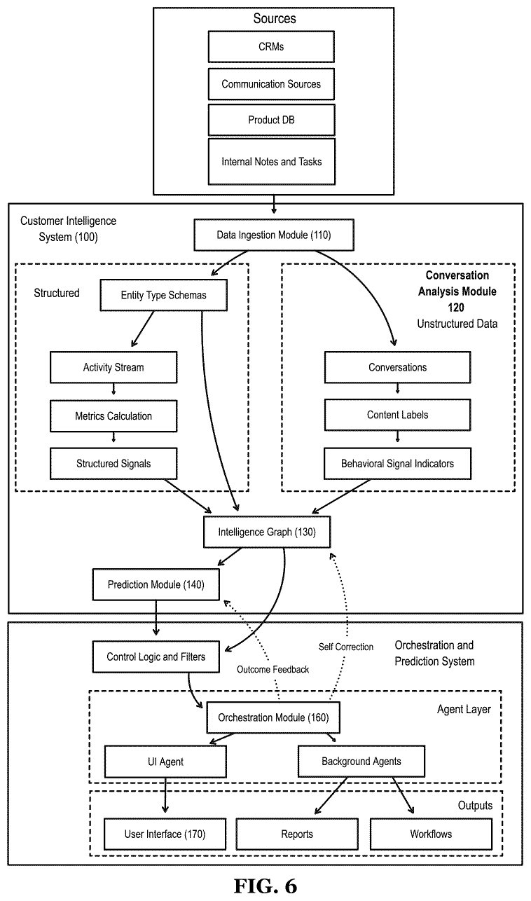

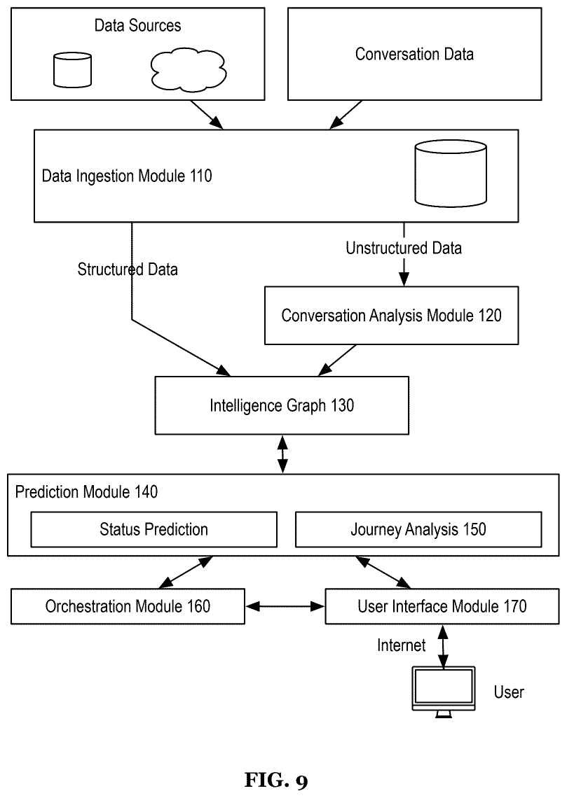

As shown in FIG. 9, a customer intelligence system 100 for generating customer intelligence from structured and unstructured data may include one or more processors and memory storing instructions that, when executed by the one or more processors, cause the system to perform the operations described herein. As shown in FIG. 6, the customer intelligence system 100 may include a data ingestion module 110 that aggregates both structured and unstructured data from various sources, a conversation analysis module 120 that analyzes unstructured conversational data using a trained language model to extract behavioral signal indicators, a customer intelligence graph 130 that stores account entities, behavioral signal entities, and temporal relationships in a unified temporal graph data structure, and a temporal analysis and prediction module 140 that performs temporal analysis on the customer intelligence graph and generates predictive account assessments. The system may additionally include a journey analysis module 150 that provides a specialized application of the temporal analysis for customer journey analysis using sequential pattern analysis techniques, an orchestration module 160 that generates and executes automated task recommendations based on the predictive assessments and graph state, and/or a user interface module 170 that provides visualization, interaction, and reporting capabilities.

The data ingestion module 110 functions to aggregate structured and unstructured data from various sources for downstream processing. The data ingestion module 110 facilitates collection of data used by the system. The data ingestion module 110 may include one or more structured data connectors and one or more unstructured data connectors.

The one or more structured data connectors may ingest data from databases, CRMs (e.g., Salesforce), data warehouses, product analytics platforms (e.g., Segment, Pendo, Mixpanel), billing systems, and other instrumentation systems. The structured data connectors may receive data via database queries, reverse ETL, API calls, webhooks, file uploads, and/or manual data entry. In some variations, the data ingestion module 110 may include a real-time data handler that processes webhooks and streaming data to enable near-real-time updates to the customer intelligence graph 130.

The one or more unstructured data connectors may ingest meeting transcripts, email correspondence, instant messages, video conferencing recordings, support chat logs, voice call transcriptions, and/or other conversational data from communication platforms. While conversational data is referenced as an exemplary type of unstructured data, any suitable type of data that can include unstructured or qualitative properties may additionally or alternatively be processed. The unstructured data connectors may connect to communication platforms via their respective APIs to retrieve conversation content.

In some variations, the data ingestion module 110 may further include a data standardization engine that transforms ingested data into standardized entity representations via configurable schema mapping. The data standardization engine may map data from heterogeneous source schemas into the predefined entity type schemas used by the customer intelligence graph 130. The data standardization engine may additionally perform data cleaning operations (e.g., removing duplicates, handling outliers, validation checks) to improve data quality prior to graph construction.

The conversation analysis module 120 functions to analyze unstructured conversational data using a trained language model to extract behavioral signal indicators (sometimes referred to as needle movers). The conversation analysis module 120 may more generally operate as an unstructured analysis module that processes any unstructured or qualitative data received by the data ingestion module 110. The conversation analysis module 120 may leverage large language models (LLMs) to extract meaningful insights from conversational data.

The conversation analysis module 120 may include a context provider that supplies product and business context information to the trained language model. The context provider may be a process or routine that can automatically add relevant contextual information to data processed by a language model. This may serve, for example, to provide customer or product relevant context to enable enhanced assessment of qualitative assessments.

The conversation analysis module 120 may further include a signal classifier that classifies conversation segments into signal categories (sometimes referred to as content labels) from a predefined signal taxonomy. The conversation analysis module 120 may further include a sentiment analyzer that associates each classified signal with a sentiment polarity value, and an excerpt extractor that extracts supporting text excerpts from the conversational data for each signal. In some variations, the conversation analysis module 120 may additionally process audio, visual, and/or video data to incorporate contextual signals such as gestures, tone, and visual cues into the extracted behavioral signal indicators.

In some variations, the system generates vector embeddings at multiple levels of abstraction. As one exemplary level, the system generates ‘content embeddings’ for the raw segments of unstructured conversational data to capture semantic nuance and context. As a second exemplary level, the system generates ‘signal embeddings’ for the extracted behavioral signal indicators (the ‘Needle Movers’) to capture the abstract categorical meaning of the detected event. These embeddings are indexed in a vector database, allowing the system to perform granular semantic searches (e.g., finding similar conversation snippets) as well as high-level pattern matching (e.g., clustering accounts with semantically similar risk signals) independent of the specific phrasing used by the customer.

The customer intelligence graph 130, which functions to store and organize account entities, behavioral signal entities, and temporal relationships in a unified temporal graph data structure, may serve as the central data structure of the customer intelligence system 100. The customer intelligence graph 130 may unify data storage into a graph structure that captures both structured and unstructured data in a single queryable representation.

The customer intelligence graph 130 may include an entity store that stores account entities derived from structured data (e.g., account models, user models, activity models conforming to predefined entity type schemas). The customer intelligence graph 130 may further include a signal store that stores behavioral signal entities derived from the extracted behavioral signal indicators. The customer intelligence graph 130 may further include a relationship engine that manages temporal relationships linking account entities and behavioral signal entities across a time dimension.

In some variations, the customer intelligence graph 130 may further include a gap tracker that tracks expected entity types per account based on the predefined entity type schemas, identifies data gaps where expected entity types are absent or where populated data exceeds a staleness threshold, and generates confidence indicators based on data completeness. In some variations, identified data gaps may be stored within the customer intelligence graph 130 as gap entities, each representing a specific deviation from a normative account health model (e.g., the absence of expected entity types, stale data, or missing relationships). The gap entities may be stored as first-class objects within the graph, enabling downstream modules (e.g., the prediction module 140 and the orchestration module 160) to query and reason about the structural completeness of each account. The predefined entity type schemas may be configurable to map to heterogeneous data source schemas.

The temporal analysis and prediction module 140, which functions to perform temporal analysis on the customer intelligence graph 130 and generate predictive account assessments, may identify patterns among the temporal relationships between account entities and behavioral signal entities for a given customer account, and may generate predictions based on the identified patterns. The temporal analysis and prediction module 140 may employ advanced machine learning algorithms to generate predictions related to customer state (e.g., churn and retention predictions). More generally, the temporal analysis and prediction module 140 may be adapted for various applications depending on the type of analysis to be performed, with each application implemented as a submodule or configuration of the module 140.

In one variation, the temporal analysis and prediction module 140 may be adapted for churn (or retention) prediction analysis, in which the module may include a structured scorer that computes a structured score from features derived from structured data using one or more machine learning models (e.g., logistic regression, random forest, decision tree, support vector machine, neural network, or an ensemble thereof); an unstructured scorer that computes an unstructured score based on temporal frequency, sentiment, and recency of the behavioral signal indicators; and a composite score calculator that combines the structured score and the unstructured score to generate the predictive account assessment. In some variations, the module 140 may further include a model trainer that trains the machine learning models on labeled historical data comprising customer accounts identified as churned or retained, with model performance evaluated by backtesting predictions against historical outcomes. When adapted for churn prediction, the module 140 may generate various output types including a customer retention likelihood score, a confidence indicator, feature contribution analysis, simulated outcome analysis, and narrative explanations.

In some variations, the predictive account assessment may be structured as a state vector comprising the account's current feature values, behavioral signal attributes, and temporal trajectory indicators, which may serve as a formal baseline representation suitable for input to downstream simulation or scenario planning processes.

In another variation, the temporal analysis and prediction module 140 may be adapted for customer journey analysis, in which case the journey analysis module 150 may operate as a specialized submodule of the module 140.

The journey analysis module 150, as shown in FIG. 8, functions to analyze customer journeys through sequential pattern analysis, benchmark discovery, and stage evaluation. The journey analysis module may operate as a specialized submodule of the temporal analysis and prediction module 140 and may perform temporal analysis on the customer intelligence graph 130 to generate journey-based account assessments. The journey analysis module 150 may use process mining techniques (or more general sequential pattern analysis) to map and analyze customer journeys. As a submodule of 140, the journey analysis module 150 may share common temporal analysis infrastructure (e.g., the customer intelligence graph 130, temporal relationship data, and entity schemas) while providing journey-specific analytical capabilities.

The journey analysis module 150 may include an event log generator that generates event logs of timestamped activity records from the customer intelligence graph 130. The journey analysis module 150 may further include a pattern analyzer that analyzes sequential activity patterns to identify activity relationships (e.g., prerequisite, parallel, and cyclical activities) and constructs journey maps by converting event logs into data structures such as Directly-Follows Graphs, Petri Nets, and Heuristics Nets. The journey analysis module 150 may further include an engagement benchmark engine that identifies recurring activities correlated with sustained customer engagement from successful accounts (sometimes referred to as a retention zone).

In some variations, the journey analysis module 150 may further include a funnel state machine that evaluates account progression through sequential stages by replaying timestamped activity records against gating conditions, and labels accounts as on-time, progressing slowly, or stalled based on comparison to historical stage duration metrics.

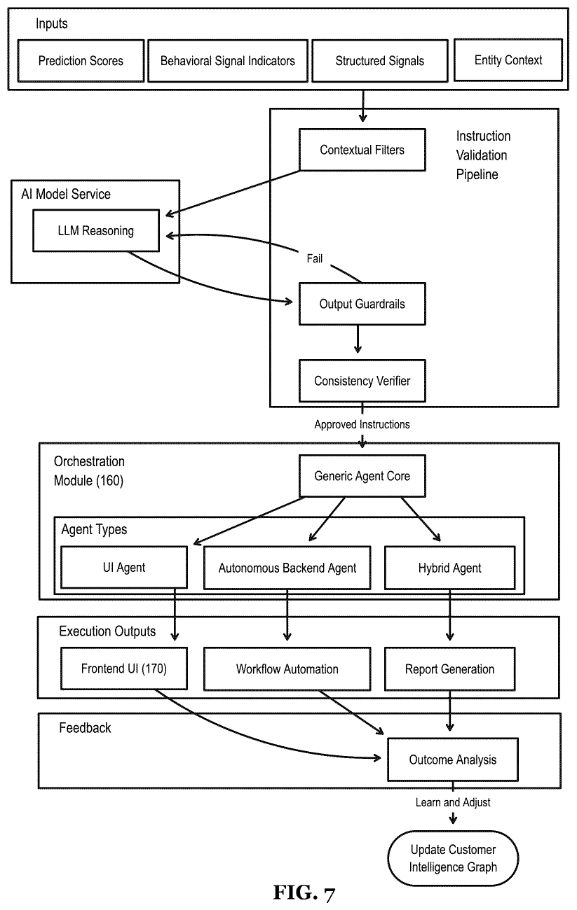

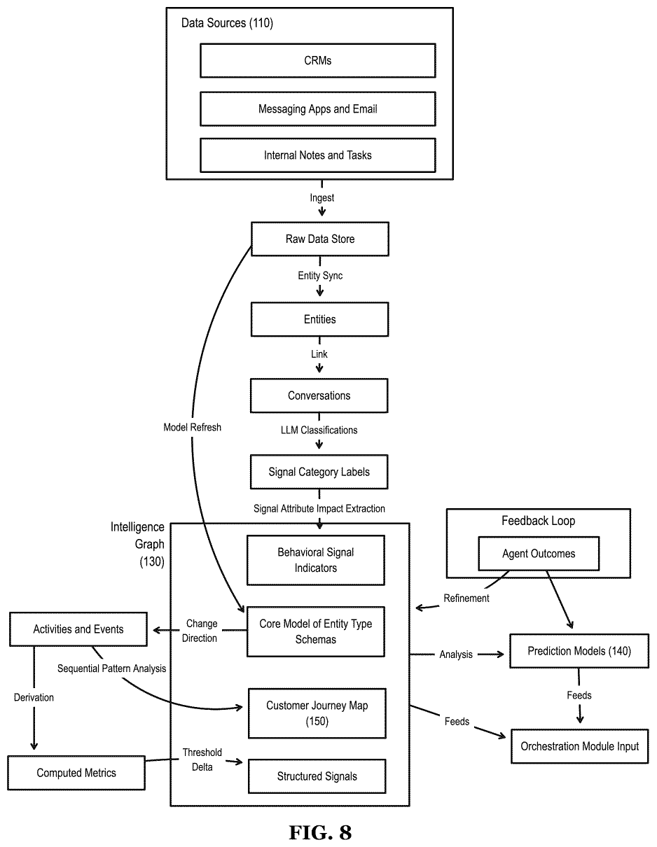

The orchestration module 160, as shown in FIG. 7, which functions to generate and execute automated task recommendations based on the predictive assessments and the current state of the customer intelligence graph 130, may translate predictions into actionable outputs. The orchestration module 160 may consolidate automated actions and workflows, data export to external systems, emitting changes, automated recommendations, and real-time alerts into a unified orchestration framework.

The orchestration module 160 may include a task generator that generates automated task recommendations based on predictive account assessments and the current graph state. The orchestration module 160 may further include a task intelligence engine that uses a language model informed by customer success practices to generate context-aware, customer-specific tasks (e.g., personalized outreach emails, meeting preparation notes, next-step recommendations). The orchestration module 160 may further include an execution engine that automatically executes tasks via programmatic integration with external systems (e.g., CRM, email, ticketing, project management).

In some variations, the orchestration module 160 may employ one or more agent types with varying levels of autonomy, including UI agents, autonomous backend agents, and/or hybrid agents. In some variations, one or more autonomous software agents may execute multi-step workflows comprising sequences of interdependent actions (e.g., retrieving account data, generating outreach content, transmitting communications, processing inbound responses, and taking conditional follow-up actions). The autonomous software agents may maintain persistent records of prior actions and responses to inform subsequent workflow steps, enabling the agents to maintain context across multiple interactions with a customer account over time. In some variations, the orchestration module 160 may further include an instruction validation pipeline comprising output guardrails and a consistency verifier that validate proposed actions before execution. In some variations, the orchestration module 160 may further support data export, change emission, real-time alerts, outcome analysis, and user feedback loops.

The user interface module 170, which functions to provide visualization, interaction, and reporting capabilities for predictions, journeys, and account status, may enable users to interact with the customer intelligence system 100 and to consume the outputs generated by the prediction module 140, the journey analysis module 150, and the orchestration module 160. The user interface module 170 may combine user interface and web portal capabilities into a single interface component.

The user interface module 170 may display predictive account assessments including churn risk scores, feature contributions, and simulated outcome analysis results, as shown in FIGS. 15-17. The user interface module 170 may present a visual representation of contributing factors, a filterable listing of customer accounts ranked by predicted status change, and a temporal trend visualization of account assessments over time. The user interface module 170 may allow users to filter predictions based on various criteria such as account type, industry, or region, and may provide visualizations such as charts and graphs to help users understand trends and patterns in the data. In some variations, the user interface module 170 may display journey maps, as shown in FIG. 19, depicting activities, journey paths, journey durations, loops, and retention zones, and may retrieve all accounts by stage for review.

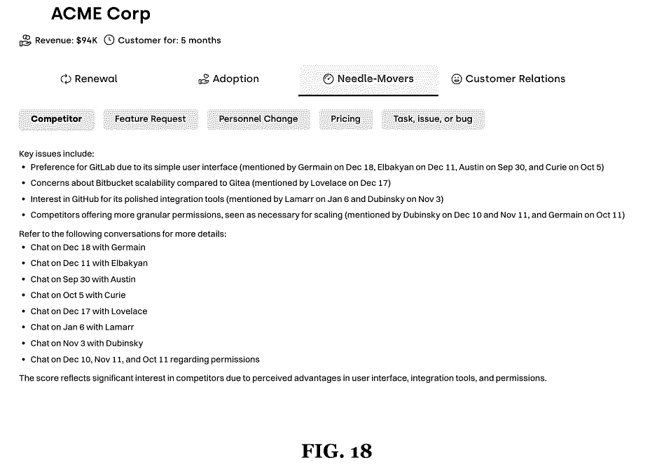

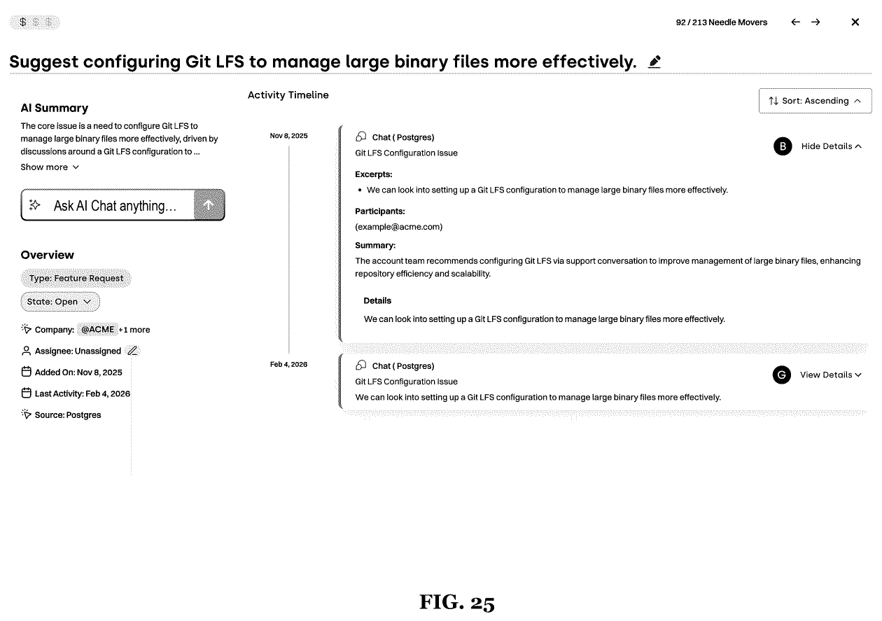

In some variations, the user interface module 170 may display behavioral signal indicator analysis (sometimes referred to as needle mover analysis) showing extracted signals, sentiment polarity, and supporting excerpts for each customer conversation, as shown in FIG. 18. As shown in FIG. 25, the user interface module 170 may additionally present a detail view for an individual behavioral signal indicator, including the signal category (e.g., feature request, pricing mention, or other category from the predefined signal taxonomy), an AI-generated summary describing the signal, an activity timeline showing chronological conversation entries associated with the signal, supporting text excerpts from each conversation, participant information, and temporal attributes such as when the signal was first detected and when the most recent associated activity occurred. The detail view may enable a user to navigate among behavioral signal indicators (e.g., browsing through a collection of extracted signals) and to inspect the underlying conversational evidence for each signal. In some variations, the user interface module 170 may provide a schema configuration interface that enables users to configure the predefined entity type schemas used by the customer intelligence graph 130. In some variations, the user interface module 170 may surface data gaps, confidence indicators, and task recommendations generated by the orchestration module 160, enabling users to take informed actions based on the system's assessments.

### 4. Exemplary Variations

Hereafter are described different aspects of various variations of the systems and methods. These aspects are not intended to limit the systems and methods and do not include every variation and combination of variations described herein. Features which are described in the context of separate aspects and variations may be used together and/or be interchangeable. Similarly, features described in the context of a single variation may also be provided separately or in any suitable sub-combination.

Variation 1.1: A computer-implemented method for generating customer intelligence, comprising: receiving, by one or more processors, structured data from one or more data sources associated with a plurality of customer accounts, the structured data comprising timestamped customer activity records; receiving unstructured conversational data associated with one or more of the plurality of customer accounts from one or more communication sources; analyzing, by a trained language model, the unstructured conversational data to extract a plurality of behavioral signal indicators, each behavioral signal indicator comprising a categorization and a temporal attribute associated with a customer account; constructing a customer intelligence graph comprising (a) account entities derived from the structured data, (b) behavioral signal entities derived from the extracted behavioral signal indicators, and (c) temporal relationships linking the account entities and the behavioral signal entities across a time dimension; performing temporal analysis on the customer intelligence graph to identify, for a given customer account, a pattern among the temporal relationships between the account entities and the behavioral signal entities associated with the given customer account; and generating, based on the identified pattern, a predictive account assessment indicating a predicted change in status of the given customer account.

Variation 2.1: A system for generating customer intelligence, comprising: one or more processors; and memory storing instructions that, when executed by the one or more processors, cause the system to perform operations comprising: receiving structured data from one or more data sources associated with a plurality of customer accounts, the structured data comprising timestamped customer activity records; receiving unstructured conversational data associated with one or more of the plurality of customer accounts from one or more communication sources; analyzing, by a trained language model, the unstructured conversational data to extract a plurality of behavioral signal indicators, each behavioral signal indicator comprising a categorization and a temporal attribute associated with a customer account; constructing a customer intelligence graph comprising (a) account entities derived from the structured data, (b) behavioral signal entities derived from the extracted behavioral signal indicators, and (c) temporal relationships linking the account entities and the behavioral signal entities across a time dimension; performing temporal analysis on the customer intelligence graph to identify, for a given customer account, a pattern among the temporal relationships between the account entities and the behavioral signal entities associated with the given customer account; and generating, based on the identified pattern, a predictive account assessment indicating a predicted change in status of the given customer account.

Variation 2.2: A variation of Variation 2.1 and/or any other system variation herein, wherein the operations further comprise: computing a structured score from features derived from the structured data using a machine learning model trained on historical customer account outcomes; computing an unstructured score based on temporal frequency, sentiment, and recency of the behavioral signal indicators associated with the given customer account; and combining the structured score and the unstructured score to generate the predictive account assessment.

Variation 3.1: A variation of Variations 1.1, 2.1, and/or any other system or method variation herein, wherein extracting the plurality of behavioral signal indicators comprises: classifying, by the trained language model, segments of the unstructured conversational data into one or more signal categories from a predefined signal taxonomy; and associating each classified segment with the signal category, a sentiment polarity value, and one or more supporting text excerpts extracted from the unstructured conversational data. The classified segments may also be associated with additional context or metadata of the unstructured data such as data type (e.g., ticket, meeting, etc.), previous thread messages, participants, grounding information (e.g., company info, offering info, competitor info), and/or other related information that can provide context to interpretation of unstructured data.

Variation 3.2: A variation of Variations 1.1, 2.1, and/or any other system or method variation herein, wherein analyzing the unstructured conversational data by the trained language model comprises: providing the trained language model with context information describing products or services of a vendor associated with the plurality of customer accounts; and extracting, by the trained language model based on the context information, the plurality of behavioral signal indicators from the unstructured conversational data.

Variation 3.3: A variation of Variation 3.1, 1.1, 2.1, and/or any other variation herein, further comprising: generating a content embedding representing a semantic vector of the segment of unstructured conversational data; generating a signal embedding representing a semantic vector of the extracted behavioral signal indicator; and indexing both the content embedding and the signal embedding in a vector index to enable semantic similarity retrieval based on either raw conversational context or extracted signal category.

Variation 4.1: A variation of Variations 1.1, 2.1, and/or any other system or method variation herein, wherein generating the predictive account assessment comprises: computing a structured score from features derived from the structured data using a machine learning model trained on historical customer account outcomes; computing an unstructured score based on temporal frequency, sentiment, and recency of the behavioral signal indicators associated with the given customer account; and combining the structured score and the unstructured score to generate the predictive account assessment.

Variation 4.2: A variation of Variation 4.1 and/or any other variation herein that includes computing a structured score, wherein the machine learning model is trained using labeled historical data comprising customer accounts identified as churned or retained, and wherein model performance is evaluated by backtesting predictions against historical customer account outcomes.

Variation 4.3: A variation of Variations 1.1, 2.1, and/or any other system or method variation herein, wherein the predictive account assessment comprises a customer retention likelihood score indicating a predicted likelihood that the given customer account will discontinue use of a product or service within a defined future time period.

Variation 4.4: A variation of Variations 1.1, 2.1, and/or any other system or method variation herein, wherein performing temporal analysis on the customer intelligence graph comprises weighting the behavioral signal indicators and the account entities based on temporal recency, such that more recent data contributes more heavily to the identified pattern.

Variation 4.5: A variation of Variation 4.1 and/or any other variation herein that includes computing a structured score, wherein the machine learning model comprises one or more of: a logistic regression model, a random forest model, a decision tree model, a support vector machine, a neural network, or an ensemble of two or more of the foregoing.

Variation 4.6: A variation of Variation 4.1 and/or any other variation herein that includes computing a structured score, wherein the structured score is computed as a weighted average of predictions from a plurality of machine learning models, wherein weights are determined based on each model's performance on a validation dataset.

Variation 4.7: A variation of Variation 4.1 and/or any other variation herein that includes computing a structured score, wherein features derived from the structured data comprise one or more of: activity frequency within a defined time window, activity count aggregations, account trait values, or computed metric values derived from customer account data.

Variation 4.8: A variation of Variation 4.1 and/or any other variation herein that includes computing an unstructured score, wherein computing the unstructured score comprises aggregating the behavioral signal indicators associated with the given customer account over a defined time period and computing a weighted sum based on signal category, sentiment polarity, and temporal recency of each behavioral signal indicator.

Variation 5.1: A variation of Variations 1.1, 2.1, and/or any other system or method variation herein, wherein performing temporal analysis on the customer intelligence graph comprises: generating an event log comprising timestamped activity records from the customer intelligence graph for the plurality of customer accounts; and analyzing sequential activity patterns across the plurality of customer accounts to identify activity relationships among the timestamped activity records.

Variation 5.2: A variation of Variation 5.1 and/or any other variation herein that includes analyzing sequential activity patterns, wherein analyzing sequential activity patterns comprises identifying one or more of: prerequisite activities that precede other activities, parallel activities that occur in any order, and cyclical activities that are performed repeatedly.

Variation 5.3: A variation of Variation 5.1 and/or any other variation herein that includes analyzing sequential activity patterns, further comprising: analyzing activity patterns of customer accounts identified as successful to identify a set of recurring activities correlated with sustained customer engagement; and using the identified set of recurring activities as benchmark criteria for evaluating whether other customer accounts have achieved sustained product value.

Variation 5.4: A variation of Variation 5.1 and/or any other variation herein that includes analyzing sequential activity patterns, further comprising: defining a plurality of sequential stages based on the identified activity relationships, wherein each stage is associated with one or more gating conditions specifying activities that must be completed to advance to a subsequent stage; and evaluating, using a state machine, progression of each customer account through the plurality of sequential stages by replaying the timestamped activity records for each customer account against the gating conditions to determine a current stage for each customer account.

Variation 5.5: A variation of Variation 5.4 and/or any other variation herein that includes evaluating progression through sequential stages, further comprising labeling each customer account as one of on-time, progressing slowly, or stalled, based on comparison of the customer account's duration in a current stage to a historical stage duration metric.

Variation 5.6: A variation of Variation 5.1 and/or any other variation herein that includes analyzing sequential activity patterns, further comprising generating a visual representation of the identified activity relationships as a customer journey map depicting activity sequences, path frequencies, and journey durations.

Variation 6.1: A variation of Variations 1.1, 2.1, and/or any other system or method variation herein, further comprising generating, based on the predictive account assessment and a current state of the given customer account within the customer intelligence graph, one or more automated task recommendations for the given customer account.

Variation 6.2: A variation of Variation 6.1 and/or any other variation herein that includes generating automated task recommendations, wherein the one or more automated task recommendations are generated by a language model informed by customer success practices.

Variation 6.3: A variation of Variation 6.1 and/or any other variation herein that includes generating automated task recommendations, further comprising automatically executing one or more of the automated task recommendations via programmatic integration with one or more external systems, wherein executing comprises one or more of: transmitting a communication to a customer contact, updating a record in a customer relationship management system, or creating a task in a project management or support system.

Variation 6.4: A variation of Variation 6.1 and/or any other variation herein that includes orchestrating actions, wherein orchestrating actions further comprises executing, by one or more autonomous software agents, a multi-step workflow based on the customer intelligence graph and the predictive account assessments, the multi-step workflow comprising two or more steps selected from: retrieving information from the customer intelligence graph or one or more external systems; generating content based on the retrieved information; transmitting communications to external parties based on the generated content; processing inbound responses or events and updating the workflow state based on received information; performing a conditional action based on an intermediate result; maintaining a persistent record of prior agent actions and external responses to inform subsequent steps; and, optionally, awaiting confirmation from a human user before executing a subsequent step.

Variation 6.5: A variation of Variations 1.1, 2.1, and/or any other system or method variation herein, further comprising exporting the predictive account assessment to one or more external systems, wherein the exporting comprises one or more of: updating a customer record in a CRM system, transmitting a notification via an API, or publishing the predictive account assessment to a reporting dashboard.

Variation 6.6: A variation of Variations 1.1, 2.1, and/or any other system or method variation herein, further comprising generating a real-time alert when the predictive account assessment for a customer account crosses a predefined threshold indicating a change in predicted account status.

Variation 6.7: A variation of Variation 6.1 and/or any other variation herein that includes orchestrating actions, wherein the customer intelligence graph queried during orchestration stores pre-computed analysis results generated during preceding method steps as first-class properties of the corresponding entities, the pre-computed analysis results comprising one or more of: behavioral signal classifications generated by the trained language model, machine learning model scores computed from structured data features, cohort membership labels identifying clusters of accounts with similar behavioral patterns, and anomaly indicators identifying accounts exhibiting activity patterns that deviate from expected norms.

Variation 7.1: A variation of Variations 1.1, 2.1, and/or any other system or method variation herein, wherein the account entities conform to predefined entity type schemas comprising account models, user models, and activity models, and wherein the predefined entity type schemas are configurable to map to heterogeneous data source schemas from the one or more data sources.

Variation 7.2: A variation of Variations 7.1 and/or any other system or method variation herein, wherein constructing the customer intelligence graph further comprises: determining, based on the predefined entity type schemas, expected entity types for each customer account; and identifying data gaps where expected entity types are absent from the customer intelligence graph or where populated entity data exceeds a staleness threshold.

Variation 7.3: A variation of Variation 7.2 and/or any other variation herein that includes identifying data gaps, wherein identifying data gaps further comprises: comparing the customer intelligence graph against a normative account health model specifying expected entity types and properties for the given customer account; and generating, for each identified gap, an explicit gap entity stored within the customer intelligence graph, the gap entity comprising a gap type identifying the nature of the missing or stale data, a reference to the expected entity type that is absent or stale, and a severity indicator.

Variation 7.4: A variation of Variation 7.2 and/or any other variation herein that includes identifying data gaps, wherein the predictive account assessment further comprises a confidence indicator generated based on completeness of data populated in the customer intelligence graph relative to the expected entity types for the given customer account.

Variation 7.5: A variation of Variations 1.1, 2.1, and/or any other system or method variation herein, wherein the temporal relationships in the customer intelligence graph comprise one or more of: user-to-account associations, activity-to-account associations, signal-to-conversation associations, and temporal orderings among activities and behavioral signal indicators.

Variation 7.6: A variation of Variation 7.1 and/or any other variation herein that includes predefined entity type schemas, wherein configuring the predefined entity type schemas comprises mapping fields from the heterogeneous data source schemas to properties of the predefined entity type schemas via a configuration interface.

Variation 7.7: A variation of Variations 1.1, 2.1, and/or any other system or method variation herein, wherein the unstructured conversational data comprises conversational data from a plurality of communication channels, and wherein the method further comprises associating conversational data from the plurality of communication channels with the same customer account based on participant identifiers.

Variation 8.1: A variation of Variations 4.1, and/or any other system or method variation herein, further comprising receiving user feedback on the predictive account assessment and incorporating the user feedback into subsequent training of the machine learning model or refinement of the trained language model.

Variation 8.2: A variation of Variation 4.1 and/or any other variation herein that includes computing a structured score, further comprising tracking prediction accuracy over time by comparing generated predictive account assessments against actual customer account outcomes, and retraining the machine learning model based on the comparison.

Variation 8.3: A variation of Variations 1.1, 2.1, and/or any other system or method variation herein, further comprising comparing the customer intelligence graph data for two or more customer accounts to identify differences in behavioral signal indicators or activity patterns that contribute to different predictive account assessments.

Variation 8.4: A variation of Variations 1.1, 2.1, and/or any other system or method variation herein, further comprising performing cluster analysis on the customer intelligence graph to identify customer accounts with similar behavioral signal indicator patterns or activity patterns.

Variation 8.5: A variation of Variation 4.1 and/or any other variation herein that includes computing a structured score and an unstructured score, further comprising generating a what-if analysis by modifying one or more features derived from the structured data or behavioral signal indicators and recomputing the predictive account assessment to determine the effect of the modification.

Variation 8.6: A variation of Variation 4.1 and/or any other variation herein that includes computing a structured score, further comprising generating a feature contribution analysis identifying which features derived from the structured data and which behavioral signal indicators contributed most to the predictive account assessment for the given customer account.

Variation 8.7: A variation of Variation 8.5 and/or any other variation herein that includes performing simulated outcome analysis, wherein the predictive account assessment is further structured as a state vector comprising the account's current feature values, behavioral signal attributes, and temporal trajectory indicators, and wherein the simulated outcome analysis operates by modifying one or more components of the state vector and recomputing the predictive account assessment based on the modified state vector.

Variation 9.1: A variation of Variations 1.1, 2.1, and/or any other system or method variation herein, further comprising presenting, via a user interface, the predictive account assessment along with one or more of: a visual representation of contributing factors, a filterable listing of customer accounts ranked by predicted status change, or a temporal trend visualization of account assessments over time.

Variation 9.2: A variation of Variations 1.1, 2.1, and/or any other system or method variation herein, further comprising generating, using a language model, a human-readable narrative explanation of the predictive account assessment, wherein the narrative explanation describes factors from the customer intelligence graph that contributed to the predicted change in status.

Variation 10.1: A variation of Variations 1.1, 2.1, and/or any other system or method variation herein, wherein the one or more data sources comprise one or more of: a customer relationship management (CRM) system, a data warehouse, a product analytics platform, a support ticketing system, a billing system, or a business intelligence platform. The data sources may additionally include internal platform data (e.g., notes or comments) created by a user of the platform. The data sources may additionally include supplementary external data sources for business intelligences like news APIs/feeds, intent providers, data brokers, and/or other sources of relevant data. These sources may be customized for different accounts and/or customers.

Variation 10.2: A variation of Variations 1.1, 2.1, and/or any other system or method variation herein, wherein the one or more communication sources comprise one or more of: meeting transcript services, email systems, instant messaging platforms, video conferencing recordings, customer support chat logs, or voice call transcriptions.

Variation 10.3: A variation of Variations 1.1, 2.1, and/or any other system or method variation herein, wherein receiving the structured data comprises one or more of: executing database queries against a relational database, extracting data via reverse ETL from a data warehouse, fetching data via API calls to third-party applications, receiving real-time data via webhooks, or processing uploaded data files.

### 5. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., non-transitory computer-readable mediums) storing instructions that, when executed by the one or more computer processors, cause a computing platform to perform operations comprising those of the system or method described herein such as: receiving structured data from one or more data sources associated with a plurality of customer accounts; receiving unstructured conversational data associated with one or more of the plurality of customer accounts from one or more communication sources; extracting behavioral signal indicators from the unstructured conversational data; constructing a customer intelligence graph; performing temporal analysis on the customer intelligence graph; and generating a predictive account assessment indicating a predicted change in status of a given customer account; and/or orchestrating actions based on the predictive account assessment.

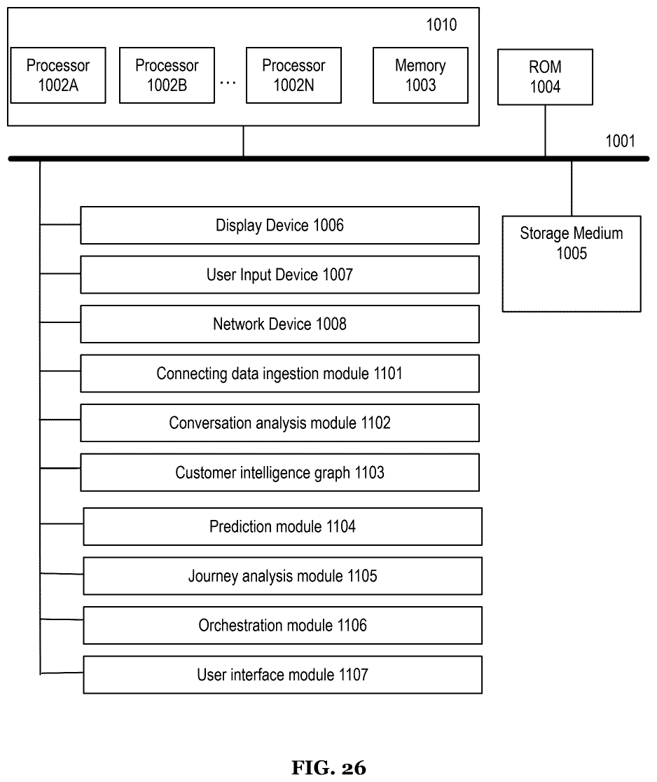

FIG. 26 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random-access memory (RAM)) 1003, a read only memory (ROM) 1004, a processor-readable storage medium 1005, a display device 1006, a user input device 1007, and a network device 1008. As shown, the computer infrastructure may be used in connecting data ingestion module 1101, conversation analysis module 1102, customer intelligence graph 1103, prediction module 1104, journey analysis module 1105, orchestration module 1106, user interface module 1107, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1002A-1002N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
receiving, by one or more processors, structured data from one or more data sources associated with a plurality of customer accounts, the structured data comprising timestamped customer activity records;
receiving unstructured conversational data associated with one or more of the plurality of customer accounts from one or more communication sources;
analyzing, by a trained language model, the unstructured conversational data to extract a plurality of behavioral signal indicators, each behavioral signal indicator comprising a categorization and a temporal attribute associated with a customer account;
constructing a customer intelligence graph comprising:
account entities derived from the structured data,
behavioral signal entities derived from the extracted behavioral signal indicators, and
temporal relationships linking the account entities and the behavioral signal entities across a time dimension;
performing temporal analysis on the customer intelligence graph to identify, for a given customer account, a pattern among the temporal relationships between the account entities and the behavioral signal entities associated with the given customer account; and
generating, based on the identified pattern, a predictive account assessment indicating a predicted change in status of the given customer account.

2. The method of claim 1, wherein extracting the plurality of behavioral signal indicators comprises:
classifying, by the trained language model, segments of the unstructured conversational data into one or more signal categories from a predefined signal taxonomy; and
associating each classified segment with the signal category, a sentiment polarity value, and one or more supporting text excerpts extracted from the unstructured conversational data.

3. The method of claim 1, wherein analyzing the unstructured conversational data by the trained language model comprises:
providing the trained language model with context information describing products or services of a vendor associated with the plurality of customer accounts; and
extracting, by the trained language model based on the context information, the plurality of behavioral signal indicators from the unstructured conversational data.

4. The method of claim 1, wherein generating the predictive account assessment comprises:
computing a structured score from features derived from the structured data using a machine learning model trained on historical customer account outcomes;
computing an unstructured score based on temporal frequency, sentiment, and recency of the behavioral signal indicators associated with the given customer account; and
combining the structured score and the unstructured score to generate the predictive account assessment.

5. The method of claim 4, wherein the machine learning model is trained using labeled historical data comprising customer accounts identified as churned or retained, and wherein model performance is evaluated by backtesting predictions against historical customer account outcomes.

6. The method of claim 1, wherein the predictive account assessment comprises a customer retention likelihood score indicating a predicted likelihood that the given customer account will discontinue use of a product or service within a defined future time period.

7. The method of claim 1, wherein performing temporal analysis on the customer intelligence graph comprises weighting the behavioral signal indicators and the account entities based on temporal recency, such that more recent data contributes more heavily to the identified pattern.

8. The method of claim 1, wherein performing temporal analysis on the customer intelligence graph comprises:
generating an event log comprising timestamped activity records from the customer intelligence graph for the plurality of customer accounts; and
analyzing sequential activity patterns across the plurality of customer accounts to identify activity relationships among the timestamped activity records.

9. The method of claim 8, wherein analyzing sequential activity patterns comprises identifying one or more of: prerequisite activities that precede other activities, parallel activities that occur in any order, and cyclical activities that are performed repeatedly.

10. The method of claim 8, further comprising:
analyzing activity patterns of customer accounts identified as successful to identify a set of recurring activities correlated with sustained customer engagement; and
using the identified set of recurring activities as benchmark criteria for evaluating whether other customer accounts have achieved sustained product value.

11. The method of claim 8, further comprising:
defining a plurality of sequential stages based on the identified activity relationships, wherein each stage is associated with one or more gating conditions specifying activities that must be completed to advance to a subsequent stage; and
evaluating, using a state machine, progression of each customer account through the plurality of sequential stages by replaying the timestamped activity records for each customer account against the gating conditions to determine a current stage for each customer account.

12. The method of claim 11, further comprising labeling each customer account as one of on-time, progressing slowly, or stalled, based on comparison of the customer account's duration in a current stage to a historical stage duration metric.

13. The method of claim 1, further comprising generating, based on the predictive account assessment and a current state of the given customer account within the customer intelligence graph, one or more automated task recommendations for the given customer account.

14. The method of claim 13, wherein the one or more automated task recommendations are generated by a language model informed by customer success practices.

15. The method of claim 13, further comprising automatically executing one or more of the automated task recommendations via programmatic integration with one or more external systems, wherein executing comprises one or more of: transmitting a communication to a customer contact, updating a record in a customer relationship management system, or creating a task in a project management or support system.

16. The method of claim 1, wherein the account entities conform to predefined entity type schemas comprising account models, user models, and activity models, and wherein the predefined entity type schemas are configurable to map to heterogeneous data source schemas from the one or more data sources.

17. The method of claim 16, wherein constructing the customer intelligence graph further comprises:
determining, based on the predefined entity type schemas, expected entity types for each customer account; and
identifying data gaps where expected entity types are absent from the customer intelligence graph or where populated entity data exceeds a staleness threshold.

18. The method of claim 17, wherein the predictive account assessment further comprises a confidence indicator generated based on completeness of data populated in the customer intelligence graph relative to the expected entity types for the given customer account.

19. A system for generating customer intelligence, comprising:
one or more processors; and
memory storing instructions that, when executed by the one or more processors, cause the system to perform operations comprising:
receiving structured data from one or more data sources associated with a plurality of customer accounts, the structured data comprising timestamped customer activity records;
receiving unstructured conversational data associated with one or more of the plurality of customer accounts from one or more communication sources;
analyzing, by a trained language model, the unstructured conversational data to extract a plurality of behavioral signal indicators, each behavioral signal indicator comprising a categorization and a temporal attribute associated with a customer account;
constructing a customer intelligence graph comprising:
account entities derived from the structured data,
behavioral signal entities derived from the extracted behavioral signal indicators, and
temporal relationships linking the account entities and the behavioral signal entities across a time dimension;
performing temporal analysis on the customer intelligence graph to identify, for a given customer account, a pattern among the temporal relationships between the account entities and the behavioral signal entities associated with the given customer account; and
generating, based on the identified pattern, a predictive account assessment indicating a predicted change in status of the given customer account.

20. The system of claim 19, wherein the operations further comprise:
computing a structured score from features derived from the structured data using a machine learning model trained on historical customer account outcomes;
computing an unstructured score based on temporal frequency, sentiment, and recency of the behavioral signal indicators associated with the given customer account; and
combining the structured score and the unstructured score to generate the predictive account assessment.

21. The method of claim 1, wherein the one or more data sources comprise one or more of: a customer relationship management (CRM) system, a data warehouse, a product analytics platform, a support ticketing system, a billing system, or a business intelligence platform.

22. The method of claim 1, wherein the one or more communication sources comprise one or more of: meeting transcript services, email systems, instant messaging platforms, video conferencing recordings, customer support chat logs, or voice call transcriptions.

23. The method of claim 1, wherein receiving the structured data comprises one or more of: executing database queries against a relational database, extracting data via reverse ETL from a data warehouse, fetching data via API calls to third-party applications, receiving real-time data via webhooks, or processing uploaded data files.

24. The method of claim 4, wherein the machine learning model comprises one or more of: a logistic regression model, a random forest model, a decision tree model, a support vector machine, a neural network, or an ensemble of two or more of the foregoing.

25. The method of claim 4, wherein the structured score is computed as a weighted average of predictions from a plurality of machine learning models, wherein weights are determined based on each model's performance on a validation dataset.

26. The method of claim 4, wherein features derived from the structured data comprise one or more of: activity frequency within a defined time window, activity count aggregations, account trait values, or computed metric values derived from customer account data.

27. The method of claim 4, wherein computing the unstructured score comprises aggregating the behavioral signal indicators associated with the given customer account over a defined time period and computing a weighted sum based on signal category, sentiment polarity, and temporal recency of each behavioral signal indicator.

28. The method of claim 1, wherein the temporal relationships in the customer intelligence graph comprise one or more of: user-to-account associations, activity-to-account associations, signal-to-conversation associations, and temporal orderings among activities and behavioral signal indicators.

29. The method of claim 1, further comprising exporting the predictive account assessment to one or more external systems, wherein the exporting comprises one or more of: updating a customer record in a CRM system, transmitting a notification via an API, or publishing the predictive account assessment to a reporting dashboard.

30. The method of claim 4, further comprising receiving user feedback on the predictive account assessment and incorporating the user feedback into subsequent training of the machine learning model or refinement of the trained language model.

31. The method of claim 4, further comprising tracking prediction accuracy over time by comparing generated predictive account assessments against actual customer account outcomes, and retraining the machine learning model based on the comparison.

32. The method of claim 1, further comprising comparing the customer intelligence graph data for two or more customer accounts to identify differences in behavioral signal indicators or activity patterns that contribute to different predictive account assessments.

33. The method of claim 1, further comprising performing cluster analysis on the customer intelligence graph to identify customer accounts with similar behavioral signal indicator patterns or activity patterns.

34. The method of claim 1, further comprising generating a real-time alert when the predictive account assessment for a customer account crosses a predefined threshold indicating a change in predicted account status.

35. The method of claim 4, further comprising generating a what-if analysis by modifying one or more features derived from the structured data or behavioral signal indicators and recomputing the predictive account assessment to determine the effect of the modification.

36. The method of claim 16, wherein configuring the predefined entity type schemas comprises mapping fields from the heterogeneous data source schemas to properties of the predefined entity type schemas via a configuration interface.

37. The method of claim 1, wherein the unstructured conversational data comprises conversational data from a plurality of communication channels, and wherein the method further comprises associating conversational data from the plurality of communication channels with the same customer account based on participant identifiers.

38. The method of claim 8, further comprising generating a visual representation of the identified activity relationships as a customer journey map depicting activity sequences, path frequencies, and journey durations.

39. The method of claim 4, further comprising generating a feature contribution analysis identifying which features derived from the structured data and which behavioral signal indicators contributed most to the predictive account assessment for the given customer account.

40. The method of claim 1, further comprising presenting, via a user interface, the predictive account assessment along with one or more of: a visual representation of contributing factors, a filterable listing of customer accounts ranked by predicted status change, or a temporal trend visualization of account assessments over time.

41. The method of claim 1, further comprising generating, using a language model, a human-readable narrative explanation of the predictive account assessment, wherein the narrative explanation describes factors from the customer intelligence graph that contributed to the predicted change in status.
